(19) United States
(12) Patent Application Publication
(10) Pub. No.: US 2022/0239007 A1
(43) Pub. Date: Jul. 28, 2022

(54) LUNEBURG LENS-BASED SATELLITE ANTENNA SYSTEM

(71) Applicant: Envistacom, LLC, Atlanta, GA (US)

(72) Inventor: Soumitra BISWAS, Peachtree Corners, GA (US)

(21) Appl. No.: 17/584,065

(22) Filed: Jan. 25, 2022

Related U.S. Application Data
(60) Provisional application No. 63/141,806, filed on Jan. 26, 2021.

(51) Int. Cl. H01Q 15/08; H01Q 15/10; H01Q 3/26

(52) U.S. Cl. CPC H01Q 15/08; H01Q 3/2658; H01Q 15/10

(57) ABSTRACT

A high-gain, wide-angle, multi-beam, multi-frequency beamforming lens antenna comprising a Luneburg lens with two sets of planar interfaces affixed to the southern hemisphere of the Luneburg lens around the exterior and a planar ultrawideband modular antenna (PUMA) structure.

### CROSS-REFERENCE TO RELATED PATENT APPLICATIONS

This patent application claims priority to U.S. Provisional Patent Application No. 63/141,806, filed Jan. 26, 2021, the disclosure of which is incorporated herein in its entirety.

### FIELD OF THE INVENTION

This disclosure relates to communications and radar antenna technology, and more particularly to broadband microwave lens antennas with relatively high gain and a wide-angle aperture and multiband microwave electronically steered lens antennas with relatively high gain and wide beamscanning angle.

### BACKGROUND OF THE INVENTION

Satellite communications (SATCOM) and terrestrial microwave communications systems such as microwave line-of-sight, cellular, and tactical networking typically require the use of transmitter/receivers connected to directional antennas that aim the energy of a signal in either a general or specific direction towards another directional antenna connected to a transmitter/receiver. A common type of antenna used in both SATCOM and terrestrial communications is a parabolic reflector with a waveguide feed located at the focal point of the parabola. These antennas are highly effective in networks where both the antenna and the distant end antenna are stationary, such as in the case of a Geosynchronous Earth Orbit (GEO) satellite, or a microwave point-to-point link between two buildings or a building and a tower.

New satellite constellations that operate in Non-Geostationary Satellite Orbit (NGSO), specifically in Medium Earth Orbit (MEO) and Low Earth Orbit (LEO), as well as the increasingly ubiquitous implementation of terrestrial communications systems that require line-of-sight and non-line-of-sight beam-steering base stations with multiple beams of energy being radiated simultaneously are challenging the paradigm of single-beam, mechanically articulated parabolic reflector antennas. Several solutions involving Electronically Steerable Array (ESA) antennas and, more specifically, Active ESA (AESA) antennas have been developed to address these new challenges. The value these terminals bring to the marketplace is their inherent ability to direct one or several energy beams in different directions without any moving parts, allowing installers to place an antenna in one position and have it connect to distant end antennas that are in motion, such as NGSO LEO and MEO communication satellites, and antennas attached to moving vehicles such as Unmanned Aerial Vehicles (UAVs) and manned aircraft. Furthermore, these antennas can be placed on a moving vehicle such as an airplane, naval vessel, or ground vehicle such as a train, automobile, and drone, and concurrently track a distant end antenna regardless of whether that antenna is also moving or not.

However, AESA antennas are expensive due to the complexity of the circuitry being used and the vast volume of elements that must be employed to replicate the gain and directivity of a parabolic reflector. AESAs also require a tremendous amount of power as they have a large number of transmit-receive (TR) modules (one at every element) all operating simultaneously when compared to parabolic antennas which require only one TR module at its single feed point. Furthermore, most implementations of AESA technology are narrow-bandwidth devices and are unable to operate across multiple frequency simultaneously.

The lens, systems, and methods described herein overcome these and other obstacles in the field to provide a low-cost, wide-angle, multi-beam, multi-frequency beamforming lens antenna.

### SUMMARY OF VARIOUS EMBODIMENTS OF THE INVENTION

The method provides a low-cost, wide-angle, multi-beam, multi-frequency beamforming lens antenna for terrestrial wireless, satellite, and radar applications.

The Luneburg (Luneburg) lens antennas described herein have technical advantages by using a variation of a Modified Luneburg Lens that allows a direct connection to a flat radiating antenna device as opposed to a curved radiating antenna device. By connecting the Planar Ultra-wideband Modular Antenna (PUMA) to the Modified Luneburg Lens with an anti-reflective layer the inventors created a class of ultra-wideband lens antennas that allows for near or complete hemispherical coverage patterns across multiple frequency ranges, useful in terrestrial wireless, satellite, and radar applications, with unexpected improvements in transmission and reception of signals.

In an embodiment, a high-gain, wide-angle, multi-beam, multi-frequency beamforming electronically steered lens antenna comprises a Luneburg lens with at least one planar interface in a southern hemisphere of the Luneburg lens and at least one Planar Ultra-wideband Modular Antenna (PUMA) array structure that is configured to function as a feed network to illuminate beams of the Luneburg lens simultaneously. The antenna may be connected between multiple networks operating at different frequencies.

In an embodiment, a Luneburg (Luneburg) lens antenna can comprise an upper hemisphere and a lower hemisphere, wherein the upper hemisphere comprises a spherical Luneburg lens, wherein the lower hemisphere comprises a plurality of geometrical interfaces arranged around the outer surface of the Luneburg lens in a southern hemisphere of the Luneburg lens, and a substantially planar bottom.

In an embodiment, the sets of pluralities of geometrical interfaces can comprise 2, 3, 4, 5, or 6 sets of pluralities of geometrical interfaces. The sets of pluralities of geometrical interfaces can comprise 2 sets of pluralities of geometrical interfaces. The pluralities of geometrical interfaces can comprise between about 4 and 20 geometrical interfaces in each set. The pluralities of geometrical interfaces can comprise between about 4, 5, 6, 7, 8, 9, 10, 11, 12, 13, 14, 15, 16, 17, 18, 19, or 20 geometrical interfaces in each set. The pluralities of geometrical interfaces can comprise about 10 geometrical interfaces in each set. In an embodiment, the geometrical interfaces may be substantially planar (flat).

In an embodiment, the sets of pluralities of geometrical interfaces at a side of the Luneburg lens in a southern hemisphere of the Luneburg lens extending around of the Luneburg lens are arranged at an angle. The angle may be between 0° and 90° with respect to the bottom of the Luneburg lens. The angle may be between about 30° and 60° degrees. The angle may be at about 0°, 1°, 2°, 3°, 4°, 5°, 6°, 7°, 8°, 9°, 10°, 11°, 12°, Ho, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89°, or 90°.

In an embodiment, there is a ledge at the mid-hemisphere conjunction of geometric interfaces comprising the lower hemisphere and the spherical Luneburg lens comprising the upper hemisphere.

In an embodiment, the pluralities of geometrical interfaces may have a near-air dielectric constant. The dielectric constant may be about 1.1. The dielectric constant may be about 1.00058986.

In an embodiment, the Planar Ultra-wideband Modular Antenna (PUMA) array structure may be matched to the Luneburg lens via an anti-reflective layer, forming a single layer of material between dipole layers of the PUMA array structure and the Luneburg lens. The anti-reflective layer may be integrated into a top layer of dielectric in the PUMA array structure or may replace the top layer of dielectric in the PUMA array structure.

In an embodiment, the Planar Ultra-wideband Modular Antenna (PUMA) array structure may be matched to the Luneburg lens via a quarter-wave long matching layer, forming a single layer of material between dipole layers of the PUMA array structure and the Luneburg lens. The quarter-wave long matching layer may be integrated into a top layer of dielectric in the PUMA array structure or may replace the top layer of dielectric in the PUMA array structure.

In an embodiment, elements of the Planar Ultra-wideband Modular Antenna (PUMA) array structure may be spaced unevenly, and each element may operate independently of adjacent elements.

In an embodiment, an illumination in a direction may be either increased or decreased, and a scan area of the antenna is increased to a full hemispherical coverage via adjusting a position of the planar interface.

In an embodiment, the southern hemisphere of the Luneburg lens may be flattened via Transformational Optics.

In an embodiment, a high-gain, wide-angle, multi-beam, multi-frequency beamforming electronically steered lens antenna can comprise a Luneburg lens with a planar interface at a bottom and a plurality of geometrical interfaces at a side of the Luneburg lens in a southern hemisphere of the Luneburg lens, and a plurality of PUMA array structures that is configured to function as a feed network to illuminate cells of the Luneburg lens simultaneously. The plurality of geometric interfaces at the side of the Luneburg lens in the southern hemisphere of the Luneburg lens may be disposed around the circumference of the Luneburg lens. The plurality of geometric interfaces may be substantially planar. The plurality of geometric interfaces can comprise between about 4 and 20 geometric interfaces, optionally about 10 geometric interfaces. The substantially planar geometric interfaces may be trapezoidal, rectangular, or square in shape. The substantially planar (e.g., flat) geometric interfaces may be a combination of trapezoidal, rectangular, and square shapes.

In an embodiment, the antenna may be connected between multiple networks operating at different frequencies.

In an embodiment, the multiple geometrically designed interfaces between the PUMA and the Luneburg lens may provide for a higher field of view and a full hemispherical coverage of the sky.

In an embodiment, the antenna may be configured to switch between satellite communications, terrestrial communications, and radar applications.

In an embodiment, a high-gain, wide-angle, multi-beam, multi-frequency beamforming lens antenna system can comprise: a Modified Luneburg lens with at least one planar interface in a southern hemisphere of the Luneburg lens; and at least one planar ultrawideband modular antenna (PUMA) array structure is operatively coupled to the planar interface, wherein the PUMA array structure is configured to function as a feed network to illuminate at least one or more beams of the Luneburg lens simultaneously; wherein the antenna is communicably coupled between multiple networks operating at different frequencies.

In an embodiment, the PUMA array structure may be matched to the Luneburg lens via an anti-reflective layer configured to form a single layer of material between dipole layers of the PUMA array structure and the Luneburg lens. The anti-reflective layer may be integrated into a top layer of dielectric in the PUMA array structure. The anti-reflective layer may be replacing a top layer of dielectric in the PUMA array structure. The anti-reflective layer may be a layer of material with specific dielectric constants at specific locations, for example at the bottom of the Luneburg lens.

In an embodiment, the feed elements of the PUMA array structure are spaced unevenly. In an embodiment, each feed element of the feed elements operates independently of adjacent elements.

In an embodiment, an illumination in a direction may be at least increased or decreased via adjusting a positioning of the planar interface.

In an embodiment, a scan area of the antenna may be increased to a full hemispherical coverage via adjusting a positioning of the planar interface. This may be achieved by adjusting the focal point of the outer layer.

In an embodiment, the southern hemisphere of the Luneburg lens may be flattened via Transformational Optics.

In an embodiment, a high-gain, wide-angle, multi-beam, multi-frequency beamforming lens antenna system can comprise: a Modified Luneburg lens with a planar interface at a bottom of the Luneburg lens and a plurality of geometrical interfaces at a side of the Luneburg lens in a southern hemisphere of the Luneburg lens; and a planar ultrawideband modular antenna (PUMA) structure may be operatively coupled to the planar interface at the bottom of the Luneburg lens and a plurality of PUMA array structures may be operatively coupled to the plurality of geometrical interfaces at the side of the Luneburg lens, wherein each of the PUMA array structures may be configured to function as a feed network to illuminate at least one or more cells of the Luneburg lens simultaneously; wherein the antenna may be communicably coupled between multiple networks operating at different frequencies. Each of the PUMA array structures may be matched to the Luneburg lens via an anti-reflective layer configured to form a single layer of material between dipole layers of each PUMA array structure and the Luneburg lens.

In an embodiment, the anti-reflective layer may be integrated into a top layer of dielectric in each of the PUMA array structures. The anti-reflective layer may be replacing a top layer of dielectric in each of the PUMA array structures. The anti-reflective layer may be a layer of material with specific dielectric constants at specific locations.

In an embodiment, the feed elements of each PUMA array structure may be spaced unevenly. Each feed element of the feed elements may operate independently of adjacent elements.

In an embodiment, the pluralities of geometrical interfaces may be configured with a plurality of planar ultra-wideband modular antenna (PUMA) antenna elements. The planar ultra-wideband modular antenna (PUMA) elements can comprise blocks of PUMA array elements, optionally an 4×4 array, 8×8 array, 16×16 array, 20×20 array, 50×50 array, 100×100 array, 250×250 array, or 300×300 array. The planar ultra-wideband modular antenna (PUMA) elements can comprise blocks between about 1 PUMA array element to about 1,000 PUMA array elements.

In an embodiment, the substantially planar bottom can comprise a plurality of flat feed surfaces along the azimuth.

In an embodiment, the Luneburg lens antenna can comprise a plurality of feed sources. The feed sources may be disposed on the geometrical interfaces, bottom, or both the geometrical interfaces and the bottom. The feed sources may be located at the edges of the adjacent substantially planar surfaces may be configured for 3 dB beam overlapping.

In an embodiment, the Luneburg lens antenna and feed sources may be electronically coupled to back-end electronics to make the lens antenna electronically beam steering. The back-end electronics may be configured to electronically switch between beams.

In an embodiment, the Luneburg lens antenna and feed sources electronically coupled to at least one low noise amplifier (LNA) configured to amplify the received signal(s). The feed sources can comprise waveguide arrays, phased array antennas, horn antennas, or combinations thereof. The Luneburg lens may be coupled to feed arrays coupled to a beam switching network. The Luneburg lens antenna and feed arrays may be coupled to a beam switching network.

In an embodiment, the feed element may be coupled to a low noise amplifier (LNA), optionally an array of LNAs. The array of LNAs may be connected through a network of switching matrix may be connected to the power source, optionally via a Wilkinson power divider network.

In an embodiment, the Luneburg lens antenna may operate over broad bandwidth. The Luneburg lens antenna may operate over a bandwidth between about 1 GHz and 40 GHz. The Luneburg lens antenna may operate over a bandwidth between about 1 GHz and 2 GHz (L-band). The Luneburg lens antenna may operate over a bandwidth between about 2 GHz and 4 GHz (S-band). The Luneburg lens antenna may operate over a bandwidth between about 4 GHz and 8 GHz (C-band). The Luneburg lens antenna may operate over a bandwidth between about 8 GHz and 12 GHz (X-band). The Luneburg lens antenna may operate over a bandwidth between about 12 GHz and 18 GHz (Ku-band). The Luneburg lens antenna may operate over a bandwidth between about 26 GHz and 40 GHz (Ka-band).

In an embodiment, the plurality of geometrical interfaces may be configured to provide a higher field of view and a full hemispherical coverage of the sky.

In an embodiment, the antenna may be configured to switch between satellite communications, terrestrial communications, and radar applications.

In an embodiment, the antenna system may have wideband frequency coverage that allows for operation in multiple frequency bands simultaneously.

In an embodiment, the antenna system can accommodate multiple simultaneous beams.

In an embodiment, the antenna system can comprise a flat interface between the Modified Luneburg Lens and the UWB Antenna.

In an embodiment, the antenna system may be configured to allow for a multitude of signals to be transmitted and received simultaneously in multiple directions in multiple frequency bands. In an embodiment, a single antenna can track signals from the horizon to zenith.

In an embodiment, the invention provides a modified Luneburg lens with a continuously varying dielectric profile. The continuous modified Luneburg lens may further comprise an anti-reflective layer. The continuous modified Luneburg lens may further comprise an anti-reflective layer on the top, bottom, or both top and bottom of the lens. The anti-reflective layer may be a discretized anti-reflective layer.

In an embodiment, the invention provides a modified Luneburg lens with a continuously varying dielectric profile. The continuous modified Luneburg lens may further comprise a matching layer. The continuous modified Luneburg lens may further comprise a matching layer on the top, bottom, or both top and bottom of the lens. The matching layer may be a discretized anti-reflective layer.

In an embodiment, a discretized modified Luneburg lens, wherein the lens material may be organized into discrete concentric layers.

In an embodiment, each layer may have a discrete layer with a dielectric constant (εᵣ) value. The dielectric constant (εᵣ) value may be between about 1 and 20. The dielectric constant (εᵣ) value may be about 1, 2, 3, 4, 5, 6, 7, 8, 9, 10, 11, 12, 13, 14, 15, 16, 17, 18, 19, or 20. The dielectric constant may be the same or different for each layer. The layers may have the same or different thickness. The dielectric constant may be different for each layer. The layers may have different thicknesses.

In an embodiment, the discretized modified Luneburg lens can comprise an anti-reflective layer. The anti-reflective layer and/or the Luneburg lens may be made of a material selected from a cast resin or a machined material. The cast resin may be polyurethane or polystyrene. The machined materials may be Delrin® (Polyoxymethylene POM), Lexan® (polycarbonate resin thermoplastic), or a combination thereof.

In an embodiment, the anti-reflective layer may be a discretized anti-reflective layer comprising concentric rings, each with a dielectric constant (εᵣ) value. The dielectric constant may be the same or different for each ring. The dielectric constant may be different for each ring. The rings may have the same or different thickness. The rings may have different thicknesses.

In an embodiment, the discretized modified Luneburg lens can comprise a matching layer. The matching layer and/or the Luneburg lens may be made of a material selected from a cast resin or a machined material. The cast resin may be polyurethane or polystyrene. The machined materials may be Delrin® (Polyoxymethylene POM), Lexan® (polycarbonate resin thermoplastic), or a combination thereof.

In an embodiment, the matching layer may be a discretized anti-reflective layer comprising concentric rings, each with a dielectric constant (εᵣ) value. The dielectric constant may be the same or different for each ring. The dielectric constant may be different for each ring. The rings may have the same or different thickness. The rings may have different thicknesses.

In an embodiment, the lens may have between about 1 and 10 discrete layers. The lens may have about 1, 2, 3, 4, 5, 6, 7, 8, 9, or 10 discrete layers.

In an embodiment, the Luneburg lens further can comprise a flat anti-reflective layer. The anti-reflective layer may be at the bottom of the modified Luneburg Lens. The flat anti-reflective layer may be discretized.

In an embodiment, the Luneburg lens further can comprise a flat matching layer. The matching layer may be at the bottom of the modified Luneburg Lens. The flat matching layer may be discretized.

In an embodiment, the flat anti-reflective layer may be discretized and the concentric rings each may have a dielectric constant (dielectric constant) [εᵣ] value. The dielectric constant (dielectric constant) [εᵣ] value for each ring may be the same or different. The dielectric constant (dielectric constant) [εᵣ] value for each ring may be different. The dielectric constant (εᵣ) may be between about 1 and 4, optionally between about 1 and 3.5. The dielectric constant (εᵣ) may be between about 1 and 4, 2 and 3, 2.5 and 3.5, 3 and 3.5, 1.5 and 4, or 2.5 and 3.75. The dielectric constant (εᵣ) may be about 1, 1.08, 1.1, 1.25, 1.5, 1.75, 2, 2.25, 2.5, 2.75, 3, 3.25, 3.5, 3.75, or 4.

In an embodiment, the flat matching layer may be discretized and the concentric rings each may have a dielectric constant (dielectric constant) [εᵣ] value. The dielectric constant (dielectric constant) [εᵣ] value for each ring may be the same or different. The dielectric constant (dielectric constant) [εᵣ] value for each ring may be different. The dielectric constant (εᵣ) may be between about 1 and 4, optionally between about 1 and 3.5. The dielectric constant (εᵣ) may be between about 1 and 4, 2 and 3, 2.5 and 3.5, 3 and 3.5, 1.5 and 4, or 2.5 and 3.75. The dielectric constant (εᵣ) may be about 1, 1.08, 1.1, 1.25, 1.5, 1.75, 2, 2.25, 2.5, 2.75, 3, 3.25, 3.5, 3.75, or 4.

In an embodiment, the discretized modified Luneburg lens may be a flattened modified Luneburg lens. The discretized flattened Luneburg lens may have a flat bottom and gradually shaped curved outside surface.

In an embodiment, the curves at the interfaces between the layers may be generalized.

In an embodiment, the interfaced sections may be non-concentric sections.

In an embodiment, the interfaced sections may be concentric sections.

In an embodiment, the discretized modified Luneburg lens can comprise a truncated pyramidal base with at least one planar side, wherein each layer of the lens and side of the truncated pyramidal base shape may have a dielectric constant (εᵣ) value. The dielectric constant (εᵣ) value of the layer of the lens and/or side of the truncated pyramidal shape may be the same or different from the dielectric constant (εᵣ) value of other layers of the lens and/or side of the truncated pyramidal shape. The dielectric constant (εᵣ) value of the layer of the lens and/or side of the truncated pyramidal shape may be different from the dielectric constant (εᵣ) value of other layers of the lens and/or side of the truncated pyramidal shape.

In an embodiment, a high-gain, wide-angle, multi-beam, multi-frequency beamforming lens antenna system can comprise: the modified Luneburg lens described herein; and a planar ultrawideband modular antenna (PUMA) array structure may be operatively coupled to the planar interface at the bottom of the Luneburg lens and a plurality of PUMA array structures may be operatively coupled to the plurality of geometrical interfaces at the side of the Luneburg lens, wherein each of the PUMA array structures may be configured to function as a feed network to illuminate at least one or more cells of the Luneburg lens simultaneously; wherein the antenna may be communicably coupled between multiple networks operating at different frequencies.

In an embodiment, the modified Luneburg lens may have a planar interface at a bottom of the Luneburg lens and a plurality of geometrical interfaces at a side of the Luneburg lens in a southern hemisphere of the Luneburg lens.

In an embodiment, each of the PUMA array structures may be matched to the Luneburg lens via a matching layer configured to form a single layer of material between dipole layers of each PUMA array structure and the Luneburg lens.

In an embodiment, each of the PUMA array structures may be matched to the Luneburg lens via an anti-reflective layer configured to form a single layer of material between dipole layers of each PUMA array structure and the Luneburg lens.

In an embodiment, the anti-reflective layer may be integrated into a top layer of dielectric in each of the PUMA array structures. The anti-reflective layer may be replacing a top layer of dielectric in each of the PUMA array structures. The anti-reflective layer may be a layer of material with specific dielectric constants at specific locations. The anti-reflective layer may be discretized.

In an embodiment, the matching layer may be integrated into a top layer of dielectric in each of the PUMA array structures. The matching layer may be replacing a top layer of dielectric in each of the PUMA array structures. The matching layer may be a layer of material with specific dielectric constants at specific locations. The matching layer may be discretized.

In an embodiment, the discretized anti-reflective layer can comprise concentric rings of material, each ring of material having a dielectric constant (εᵣ). The dielectric constant (εᵣ) of each ring of material may be the same or different from another ring in the anti-reflective layer. The dielectric constant (εᵣ) of each ring of material may be different from another ring in the anti-reflective layer. The material of each ring may be the same or different from another ring in the anti-reflective layer. The material of each ring may be different from another ring in the anti-reflective layer. The material of each ring may be the same as another ring in the anti-reflective layer.

In an embodiment, the discretized matching layer can comprise concentric rings of material, each ring of material having a dielectric constant (εᵣ). The dielectric constant (εᵣ) of each ring of material may be the same or different from another ring in the anti-reflective layer. The dielectric constant (εᵣ) of each ring of material may be different from another ring in the anti-reflective layer. The material of each ring may be the same or different from another ring in the anti-reflective layer. The material of each ring may be different from another ring in the anti-reflective layer. The material of each ring may be the same as another ring in the anti-reflective layer.

In an embodiment, the quarter-wave long matching layer may be integrated into a top layer of dielectric in each of the PUMA array structures. The quarter-wave long matching layer may be replacing a top layer of dielectric in each of the PUMA array structures. The quarter-wave long matching layer may be a layer of material with specific dielectric constants at specific locations. The anti-reflective layer may be discretized.

In an embodiment, the discretized quarter-wave long matching layer can comprise concentric rings of material, each ring of material having a dielectric constant (εᵣ). The dielectric constant (εᵣ) of each ring of material may be the same or different from another ring in the quarter-wave long matching layer. The dielectric constant (εᵣ) of each ring of material may be different from another ring in the quarter-wave long matching layer. The material of each ring may be the same or different from another ring in the quarter-wave long matching layer. The material of each ring may be different from another ring in the quarter-wave long matching layer. The material of each ring may be the same as another ring in the quarter-wave long matching layer.

In an embodiment, the feed elements of each PUMA array structure may be spaced unevenly.

In an embodiment, each feed element of the feed elements may operate independently of adjacent elements.

In an embodiment, the plurality of geometrical interfaces provides a higher field of view and a full hemispherical coverage of the sky.

In an embodiment, the antenna system may have wideband frequency coverage that allows for operation in multiple frequency bands simultaneously.

In an embodiment, the antenna system can accommodate multiple simultaneous beams.

In an embodiment, the antenna system can comprise a flat interface between the Modified Luneburg Lens and the UWB Antenna.

In an embodiment, the antenna system may be configured to allow for a multitude of signals to be transmitted and received simultaneously in multiple directions in multiple frequency bands.

In an embodiment, the antenna system may be configured such that a single antenna can track signals from the horizon to zenith.

In an embodiment, a method for manufacturing a discretized modified Luneburg lens can comprise fabricating discrete lens shells and assembling them to form a discretized Luneburg lens. The fabrication of the discrete lens shells can comprise casting in a mold, machining from a solid piece of material (subtractive manufacturing), made using an additive manufacturing process (3D printing), or a combination thereof. The layers may be cast individually, nested together, and assembled using an adhesive.

In an embodiment, the Luneburg lens can comprise multiple concentric layers, wherein each layer has a fixed dielectric constant, and the lower hemisphere comprising a plurality of geometrical interfaces arranged around the outer surface of the Luneburg lens in a southern hemisphere of the Luneburg lens, and a substantially planar bottom layer have a fixed low dielectric constant. The concentric layers may have the same or different dielectric constants. The concentric layers may have the different dielectric constants. The concentric layers and the bottom may have the same or different dielectric constants. The concentric layers and the bottom may have different dielectric constants.

In an embodiment, the dielectric constant (εᵣ) may be between about 1 and 4, 1 and 3.5, 1 and 4, 2 and 3, 2.5 and 3.5, 3 and 3.5, 1.5 and 4, or 2.5 and 3.75. The dielectric constant (εᵣ) may be about 1, 1.08, 1.1, 1.25, 1.5, 1.75, 2, 2.25, 2.5, 2.75, 3, 3.25, 3.5, 3.75, or 4. The fixed low dielectric constant may be about 1.08.

In an embodiment, the Luneburg lens may have a very high aperture efficiency. The lens may have an aperture efficiency of between about 60% and 80%. The lens may have an aperture efficiency of between about 60% and 70%.

In an embodiment, the Luneburg lens antenna may be configured to track multiple satellites by using multiple beams generated by different feed elements.

In an embodiment, at least one planar ultrawideband modular antenna (PUMA) array structure may be operatively coupled to the planar interface, wherein the PUMA array structure may be configured to function as a feed network to illuminate at least one or more beams of the Luneburg lens simultaneously; wherein the antenna may be communicably coupled between multiple networks operating at different frequencies. The planar ultra-wideband modular antenna (PUMA) array structure may be matched to the Luneburg lens via an anti-reflective layer configured to form a single layer of material between dipole layers of the PUMA array structure and the Luneburg lens.

In an embodiment, the Luneburg lens antenna may further comprise an anti-reflective layer. The anti-reflective layer may be integrated into a top layer of dielectric in the planar ultra-wideband modular antenna (PUMA) structure. The anti-reflective layer may be replacing a top layer of dielectric in the PUMA array structure. The anti-reflective layer may be a layer of material may have a dielectric constant.

In an embodiment, the Luneburg lens antenna may further comprise a matching layer. The matching layer may be integrated into a top layer of dielectric in the planar ultra-wideband modular antenna (PUMA) array structure. The matching layer may be replacing a top layer of dielectric in the PUMA array structure. The matching layer may be a layer of material may have a dielectric constant. The matching layer may be at the bottom of the Luneburg lens. The Luneburg lens further can comprise a matching layer on the top, bottom, or both top and bottom of the lens. The matching layer can be a discretized matching layer.

In an embodiment, the dielectric constant (εᵣ) of the anti-reflective layer may be between about 1 and 4, 1 and 3.5, 1 and 4, 2 and 3, 2.5 and 3.5, 3 and 3.5, 1.5 and 4, or 2.5 and 3.75. The dielectric constant (εᵣ) of the anti-reflective layer may be about 1, 1.25, 1.5, 1.75, 2, 2.25, 2.5, 2.75, 3, 3.25, 3.5, 3.75, or 4.

In an embodiment, the anti-reflective layer may be at the bottom of the Luneburg lens.

In an embodiment, the dielectric constant (εᵣ) of the matching layer may be between about 1 and 4, 1 and 3.5, 1 and 4, 2 and 3, 2.5 and 3.5, 3 and 3.5, 1.5 and 4, or 2.5 and 3.75. The dielectric constant (εᵣ) of the matching layer may be about 1, 1.25, 1.5, 1.75, 2, 2.25, 2.5, 2.75, 3, 3.25, 3.5, 3.75, or 4.

In an embodiment, the matching layer may be at the bottom of the Luneburg lens.

In an embodiment, the feed elements of the PUMA array structure may be spaced unevenly. Each feed element of the feed elements may operate independently of adjacent elements.

In an embodiment, the illumination in a direction may be at least increased or decreased via adjusting a positioning of the planar interface.

In an embodiment, the scan area of the antenna may be increased to a full hemispherical coverage via adjusting a positioning of the planar interface.

In an embodiment, the southern hemisphere of the Luneburg lens may be flattened via Transformational Optics.

In an embodiment, the planar ultra-wideband modular antenna (PUMA) array structure may be operatively coupled to the planar interface at the bottom of the Luneburg lens and a plurality of PUMA array structures may be operatively coupled to the plurality of geometrical interfaces at the side of the Luneburg lens, wherein each of the PUMA array structures may be configured to function as a feed network to illuminate at least one or more cells of the Luneburg lens simultaneously; wherein the antenna may be communicably coupled between multiple networks operating at different frequencies.

In an embodiment, each of the PUMA array structures may be matched to the Luneburg lens via an anti-reflective layer configured to form a single layer of material between dipole layers of each PUMA array structure and the Luneburg lens.

In an embodiment, each of the PUMA array structures may be matched to the Luneburg lens via a matching layer configured to form a single layer of material between dipole layers of each PUMA array structure and the Luneburg lens.

In an embodiment, the plurality of geometrical interfaces provides a higher field of view and a full hemispherical coverage of the sky.

In an embodiment, the antenna may be configured to switch between satellite communications, terrestrial communications, and radar applications.

In an embodiment, the antenna has wideband frequency coverage that allows for operation in multiple frequency bands simultaneously.

In an embodiment, the antenna can accommodate multiple simultaneous beams.

In an embodiment, the antenna can comprise a Luneburg Lens and a UWB Antenna coupled together by a substantially planar interface.

In an embodiment, the antenna system may be configured to allow for a multitude of signals to be transmitted and received simultaneously in multiple directions in multiple frequency bands.

In an embodiment, the antenna system may be configured to allow a single antenna to track signals from the horizon to zenith.

In an embodiment, the Luneburg lens has a continuously varying dielectric profile.

In an embodiment, the Luneburg lens may be a discretized Luneburg lens.

In an embodiment, the lens material may be organized into discrete concentric layers. Each layer may have a discrete layer with a dielectric constant (εᵣ) value. The dielectric constant (εᵣ) value may be between about 1 and 20. The dielectric constant (εᵣ) value may be about 1, 2, 3, 4, 5, 6, 7, 8, 9, 10, 11, 12, 13, 14, 15, 16, 17, 18, 19, or 20. The dielectric constant may be the same or different for each layer. The dielectric constant may be different for each layer.

In an embodiment, the layers may have the same or different thickness. The layers may have different thicknesses. The Luneburg lens can comprise between about 1 and 10 discrete layers. The Luneburg lens may have about 1, 2, 3, 4, 5, 6, 7, 8, 9, or 10 discrete layers.

In an embodiment, the anti-reflective layer may be made of a material selected from a cast resin or a machined material. In an embodiment, the Luneburg lens may be made of a material selected from a cast resin or a machined material. The cast resin may be polyurethane or polystyrene. The machined materials are Delrin® (Polyoxymethylene POM), Lexan® (polycarbonate resin thermoplastic), or a combination thereof.

In an embodiment, the anti-reflective layer may be a discretized anti-reflective layer comprising concentric rings, each with a dielectric constant (εᵣ) value. The dielectric constant may be the same or different for each ring. The dielectric constant may be different for each ring. The rings may have the same or different thickness. The rings may have the thickness. The rings may have different thicknesses.

In an embodiment, the matching layer may be made of a material selected from a cast resin or a machined material. In an embodiment, the Luneburg lens may be made of a material selected from a cast resin or a machined material. The cast resin may be polyurethane or polystyrene. The machined materials are Delrin® (Polyoxymethylene POM), Lexan® (polycarbonate resin thermoplastic), or a combination thereof.

In an embodiment, the matching layer may be a discretized matching layer comprising concentric rings, each with a dielectric constant (εᵣ) value. The dielectric constant may be the same or different for each ring. The dielectric constant may be different for each ring. The rings may have the same or different thickness. The rings may have the thickness. The rings may have different thicknesses.

In an embodiment, a high-gain, wide-angle, multi-beam, multi-frequency beamforming lens antenna system can comprise the Luneburg lens antenna described herein.

In an embodiment, a method of making the Luneburg lens antenna described herein can comprise machining a solid material into the desired shape. In an embodiment, a method of making the Luneburg lens antenna described herein can comprise using a 3D printing technique to make the Luneburg lens. Air-holes may be used to spatially change the lens' three-dimensional dielectric profile.

In an embodiment, a method of making the Luneburg lens antenna described herein can comprise fabricating discrete lens shells and assembling them to form a discretized Luneburg lens. The fabrication of the discrete lens shells can comprise casting in a mold, machining from a solid piece of material (subtractive manufacturing), made using an additive manufacturing process (3D printing), or a combination thereof. The layers may be cast individually, nested together, and assembled using an adhesive.

Other features and advantages of the present invention will become apparent from the following more detailed description, taken in conjunction with the accompanying drawings, which illustrate, by way of example, the principles of the inventions.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The advantages and features of the present invention will become better understood with reference to the following more detailed description taken in conjunction with the accompanying drawings in which:

FIG. 1 depicts a Luneburg (Luneburg) lens showing two different points of excitation and two beams being formed through the lens.

FIG. 2 illustrates the principle of generalized Luneburg lens in which the focal point can be moved away from the surface of the Luneburg lens structure.

FIG. 3 depicts an example of a practical implementation of the Luneburg lens structure.

FIG. 4 depicts a schematic diagram of a modified Luneburg lens comprising a flattened bottom, is coupled to a feed assembly, which can be a printed circuit board since it is mating to a flat lens, and coupled to an associated electronics and switch assembly, which may be a printed circuit assembly (PCB).

FIG. 5 depicts a cross-section view of another example of a modified Luneburg lens coupled to a planar ultra-wideband modular antenna (PUMA) feed board and a connector board.

FIG. 6 depicts the calculated permittivity distribution inside the modified Luneburg Lens without an anti-reflective layer.

FIG. 7 depicts examples of PUMA implementation. FIG. 7A depicts a mechanically assembled PUMA feed array board which can be implemented with a flat-bottom Luneburg lens.

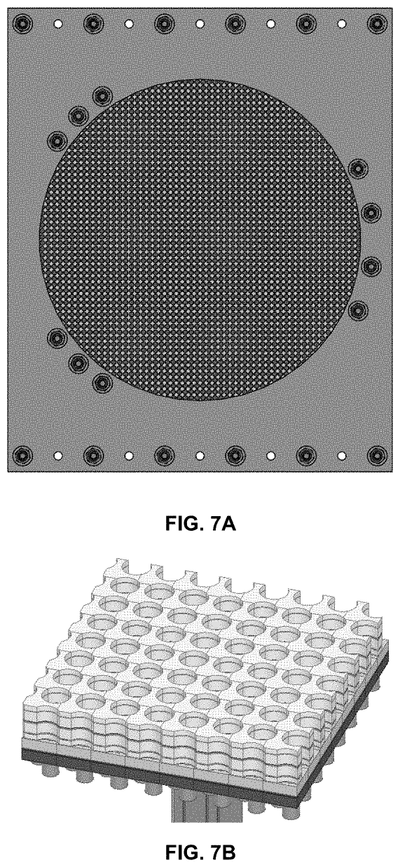

FIG. 7B depicts the multi-layer stackup of a sample PUMA feed board with connectors at the bottom.

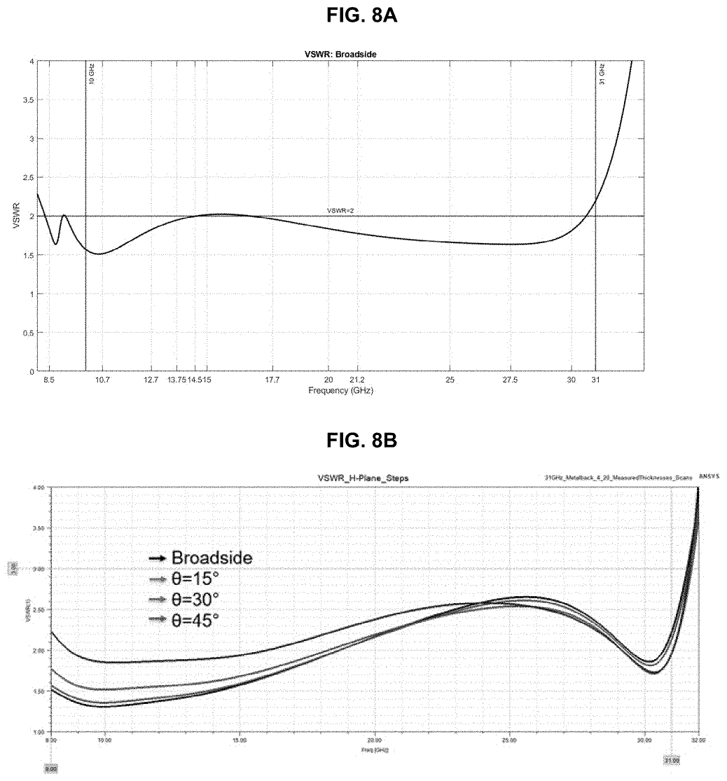

FIG. 8A depicts graphs showing the simulated return loss performances of the PUMA array.

FIG. 8B depicts a graph showing the simulated return loss performance for different radiation angles.

FIG. 9 depicts a modified Luneburg Lens that can cover approximately +/−50 degrees elevation angle.

FIG. 10 depicts adjacent feeds servicing adjacent beams, in accordance with the present disclosure.

FIG. 11A depicts the calculated permittivity distribution of a modified Luneburg lens antenna via transformation optics. FIG. 11B depicts the discretization of the continuous permittivity profile of the modified Luneburg lens antenna. The discretized profile has several discrete concentric rings and one outer non-concentric shell at the bottom.

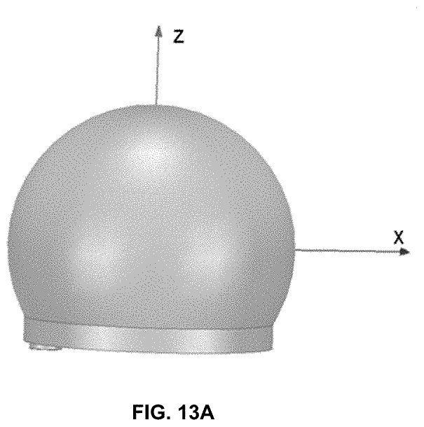

FIG. 12A depicts a modified Luneburg lens with a flattened bottom and six-flattened panels (cupcake shape) with a PUMA array attached.

FIG. 12B depicts a modified Luneburg lens with a flattened bottom and six-flattened panels (cupcake shape) with a PUMA array attached (titled view to show the bottom).

FIG. 13A-B depicts two embodiments of a modified Luneburg lens, continuous lens (A) where the lens material has spatially varying continuous dielectric profile, and (B) discretized lens, where the lens material is organized into discrete concentric layers.

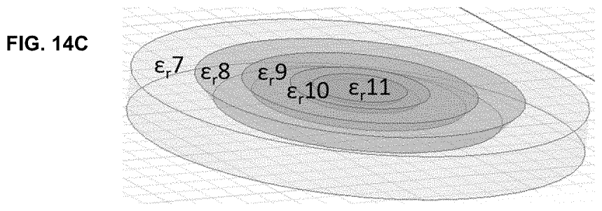

FIG. 13A-C depicts an embodiment of a modified Luneburg lens comprising a flat anti-reflective layer at the bottom of the modified Luneburg Lens (A), a cross sectional view of the discretized modified Luneburg lens with discretized flat anti-reflective layer at the bottom showing the discrete, concentric layers each with a dielectric constant (dielectric constant) [εᵣ], which may be the same or different, optionally different, and the layers may be of the same or different thickness, optionally different; (B) depicts a cross-section of the discretized modified Luneburg lens showing the concentric layers with a dielectric constant (εᵣ); and (C) depicts a top view of the discretized anti-reflective layer at the bottom of the discretized modified Luneburg lens, each layer having a dielectric constant (εᵣ). The dielectric constant (εᵣ) value may be between about 1 and 20. The dielectric constant (εᵣ) value may be about 1, 2, 3, 4, 5, 6, 7, 8, 9, 10, 11, 12, 13, 14, 15, 16, 17, 18, 19, or 20. The dielectric constant (εᵣ) value is preferably about 1, 2, 3, 4, or between about 1-4.

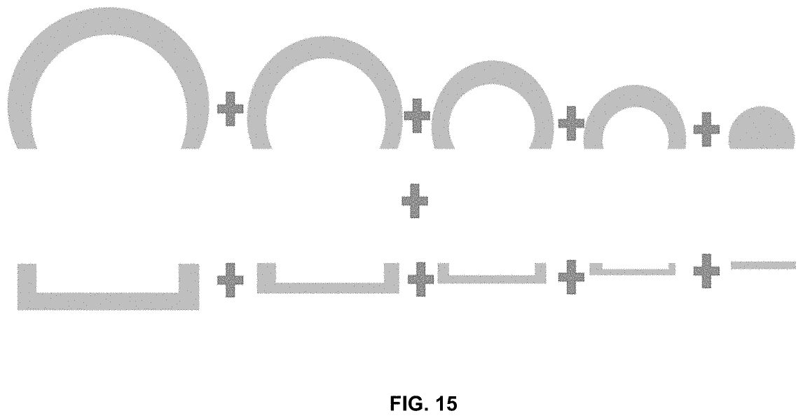

FIG. 15 depicts an embodiment of manufacturing a discretized Luneburg lens comprising fabricating discrete pseudo-cylindrical structures and lens shells, then assembling them to form a discretized Luneburg lens.

FIG. 16A-B depicts a continuous dielectric cupcake shaped Luneburg lens (A) and a discretized dielectric cupcake-shaped lens (B). Each layer and side of the modified Luneburg lens with a pyramidal base (“cupcake shape”) may have a dielectric constant (εᵣ) value, that may be the same or different, optionally different, from other dielectric constant (εᵣ) value. In an embodiment, the bottom hemisphere of the modified Luneburg lens may have a flat bottom with a series of planar sections (“cupcake shape”). At least one planar interface in the lower hemisphere of the cupcake-shaped Luneburg lens, continuous or discretized, may be coupled to a planar ultrawideband modular antenna (PUMA) array structure. The PUMA array structure may be connected to at least one of the planar interfaces of the Luneburg lens and is configured to function as a feed network to illuminate cells of the Luneburg lens simultaneously.

FIG. 17A-B depicts a Luneburg lens with two sets of substantially planar sections extending around the perimeter of the Luneburg lens. The substantially planar sections may be mechanically coupled to the Luneburg lens. The Luneburg lens can comprise between about 1 and 20 substantially planar interfaces in each set, optionally about 10 substantially planar interfaces, and can comprise at least one or two sets of substantially planar interfaces. The sets of substantially planar interfaces may be arranged at an angle, relative to a horizontal plane intersecting the central axis, e.g., relative to the substantially planar bottom. The angle between The Luneburg lens depicted in FIG. 17A-B has a substantially planar bottom, e.g., at the bottom of the southern hemisphere. The angle may be between about 0° and 90°, optionally at about 30° to about 60°. In one embodiment, there is a ledge between the Luneburg lens and the substantially planar interfaces. The ledge may be between about 1 mm and 2 m in size, as measured from the outer surface of the spherical shape of the upper hemisphere to the edge of the ledge formed by the geometric lower hemisphere. The Luneburg lens may be smaller, e.g., about 5 mm in diameter, or larger, e.g., about 5 M in diameter. The Luneburg lens may be a continuous dielectric lens or a discretized dielectric lens. FIG. 17A is a side view and FIG. 17B is a bottom view.

FIG. 18 depicts an embodiment of manufacturing a discretized Luneburg lens comprising fabricating a Luneburg lens comprising discrete lens shells, and a bottom portion comprising two sets of substantially planar interfaces and a substantially planar bottom, then assembling them to form a discretized Luneburg lens comprising a Luneburg lens comprising discrete lens shells, and a bottom portion comprising two sets of substantially planar interfaces and a substantially planar bottom. In FIG. 18, a discretized Luneburg lens comprising layers of different thickness is depicted. The discretized Luneburg lens can comprise layers with substantially the same thickness. In an embodiment, a Luneburg lens may be added to a “cupcake shaped” lower dielectric material surrounding the lens. In one embodiment, the lens' dielectric value changes from 2 (at the center) to 1 (at the edge).

FIG. 19A-B depicts 2D “cupcake” lens design using transformation Optics. In this design embodiment, a 2D version of the spherical Luneburg lens is modified into a cupcake structure (as shown in FIG. 19A) by solving the Laplace equation, and the dielectric profile of the modified 2D lens is calculated utilizing quasi-conformal transformation optics (QCTO) technique. The 3D version of the modified lens is designed by axisymetrically rotating the 2D design. The axisymetrically rotated 3D design will have a spherical surface at the sides, and to achieve flat surface at the sides, the lens is then transformed into a cupcake shape by eliminating some portions of the lens surface.

FIG. 20 depicts the lens excitation (feed source) for horizon-horizon beamscanning. The designed lens can be excited with several waveguide arrays (or PUMA feed arrays) placed along each of the planar surface.

FIG. 21 depicts an exemplary receive beam switching architecture of the lens antenna described herein.

FIG. 22 depicts a comparison of gain (dBi) versus elevation angle (degrees) depicting a picture of the simulated radiation patterns of the lens without the presence of the blockage from the opposite side. The lens was excited at 3 planar surfaces. A Luneburg Lens described herein was excited with a WR75 waveguide three planar surfaces (left top, left middle and bottom surface). The waveguide position was mechanically moved at different feed locations along the constant azimuth cut-plane.

FIG. 23 depicts an exemplary Luneburg lens described herein comprising discrete lens shells, and a bottom portion comprising two sets of substantially planar surfaces and a substantially planar bottom. The exemplary Luneburg lens depicted here comprises a ledge 45 between the spherical upper hemisphere and the geometric panels in the lower hemisphere.

FIG. 24 depicts an exemplary Luneburg lens antenna described herein comprising two sets of trapezoidal shaped planar surfaces in the elevation direction and 10 trapezoidal planar surfaces in the azimuth direction. Several waveguide exemplary feed elements are shown attached to the trapezoidal planar surfaces. The radiation patterns show that the transition between the neighboring surfaces does not cause any interruption. The two neighboring feed elements located at the two adjacent surfaces along the elevation plane has a 3 dB crossover point and the angular peak beam span is 4-degree.

FIG. 25 depicts an exemplary Luneburg lens antenna described herein comprising two sets of trapezoidal shaped planar surfaces in the elevation direction and 10 trapezoidal planar surfaces in the azimuth direction. Several exemplary feed elements are shown attached to the trapezoidal planar surfaces. The antenna radiation patterns and the beam transition between the adjacent surfaces are shown. The successive beams resulting from the two feed elements located at the two adjacent sides (red shaded panels) creates a 3 dB beam overlapping. The two neighboring feed elements located at the two adjacent surfaces along the elevation plane has a 3 dB crossover point and the angular peak beam span is 4-degree.

### DETAILED DESCRIPTION OF PREFERRED EMBODIMENTS

This disclosure provides for a high-gain, wide-angle, multi-beam, multi-frequency beamforming lens antenna that includes a Luneburg lens with at least one planar interface in the southern hemisphere of the Luneburg lens and a planar ultrawideband modular antenna (PUMA) array structure. The PUMA array structure is connected to at least one of the planar interfaces of the Luneburg lens and is configured to function as a feed network to illuminate cells of the Luneburg lens simultaneously. The antenna is connected between multiple networks operating at different frequencies. An alternative class of antennas, specifically lens-based antennas exist. U.S. Pat. No. 2,328,157.

Conventional spherical lens antennas are suited for multi-beam applications as they allow signals to travel through them at many various angles without interfering with one another. However, conventional spherical lens antennas are difficult and expensive to manufacture as the radio energy feed assemblages must be connected to the lens around the lower hemisphere, requiring a physical connection to various points along a curved surface. This makes it difficult to move a signal from one portion of the lens to another, usually requiring a complex mechanically driven moving feed assemblage. Multiple beams are even more difficult as the various moving mechanical assemblages must not interfere with one another. These factors also add to cost in manufacturing.

A type of radio frequency optical lens, called a Modified Luneburg (Luneburg) Lens, uses transformational optics (TO) mathematics to flatten the lower hemisphere of the spherical lens, allowing for a flat printed circuit board antenna to be connected to the lower hemisphere of the lens. The Modified Luneburg Lens has an inherently broadband nature to the device, allowing for signals in a plurality of octaves to transit the lens in the desired directions. U.S. patent application Ser. No. 17/103,667, filed Nov. 24, 2020, now U.S. Patent Application Publication No. 2021/0159597, herein incorporated by reference in its entirety, describes an antenna that marries a PUMA class feed structure to a modified Luneburg lens to create a wideband antenna.

A challenge in the art is to find a mechanism for connecting this lens to an ultra-wideband (UWB) antenna that can also transmit and receive signals in a plurality of octaves in frequency through many or all of the antenna ports of the Modified Luneburg Lens.

A class of ultra-wideband antennas, one of which is called a Planar Ultrawideband Multiband Antenna (PUMA), use a configuration of dipoles in order to create a broadband antenna that can transmit and receive radio signals in a plurality of octaves of frequency. U.S. Patent Application Publication No. 2018/0040955. While UWB antennas such as the PUMA are able to transmit multiple beams simultaneously, the scan angle of the PUMA is only +/−55 degrees from boresite (zenith), below which the radiated signal begins to degrade in both insertion loss and axial ratio. Furthermore, the PUMA is typically used as an array of antennas and has not been connected to a lens to create a broadband lens antenna system.

UWB antennas and Luneburg Lenses are difficult connected to one another successfully. The challenge in doing so resides in connecting a flat array antenna to a spherical object, and matching the impedance of the UWB antenna to the Luneburg Lens, as typically both devices must have their impedance match free space, resulting in a complex matching challenge.

One practical problem with graded dielectric lens antenna is that the currently used methods for manufacturing the lens structure, such as additive manufacturing, are slow, expensive, and prone to problems. A large lens can take several weeks to print using additive manufacturing, and a glitch anywhere during the process can ruin the entire lens, so extreme caution must be taken to avoid mistakes. The methods described herein encompass a process and structure for manufacturing a lens that is faster, less expensive, and suitable for higher volume manufacturing.

The disclosure further provides for a method to design and build non-concentric gradient-index (GRIN) dielectric structure. A method to build an anti-reflective layer enabled modified Luneburg lens antenna using non-concentric dielectric shells is described. The method utilizes non-concentric spherical shaped dielectric structures to build a modified Luneburg lens and incorporated with an anti-reflective layer at the bottom. The anti-reflective layer can be built by using several non-concentric cylindrical shaped dielectric shells. The process may be extended to other non-uniform Luneburg and stepped gradient lenses. For example, non-uniform modified Luneburg geometries include but Cylindrical, elliptical, cupcake (truncated pyramid base), and convex shapes. These non-uniform Luneburg geometries may be discretized modified Luneburg lens.

The inventors explored a new technological approach that seemed to be a promising field of experimentation, but the technical information in the art only gave general guidance as to the particular form of the system and methods described herein or how to achieve it. The inventors suspiring found that by connecting the two elements by removing the top dielectric layer of the PUMA array and using the Modified Luneburg Lens to match the impedance of the dipole elements of the PUMA to the Luneburg lens instead of matching the impedance to free space. By connecting the PUMA array to the Modified Luneburg Lens with the removal of the top dielectric layer of the PUMA, the inventors created a more easily manufactured lens antenna that provides multiple simultaneous beams with high directivity and low side-lobes. Instead of using the PUMA as an array of feeds that create gain through phasing, the inventors can illuminate one element of the PUMA at a time in order to develop a transmit and receive beam in the desired direction based on where the beam illuminates the lens. The spacing between the PUMA array and Modified Luneburg Lens impacts the grating lobes and side-lobe interference is preferably minimized.

Connecting a Modified Luneburg Lens to a typical phased array antenna, such as a patch array or slot array, requires multiple independent feed networks, each possessing their own phase shifters and other key elements, increasing the cost and complexity of the apparatus. By implementing the PUMA array instead of a typical phased array, the inventors found that no phase shifters are necessary, as well as no dielectric layer for the PUMA.

Embodiments of the present disclosure provide systems and methods that enable an ultra-wideband, high-gain, wide-angle, multi-beam array/lens antenna system that creates an electronically steered array (ESA) lens antenna.

### Definitions

Unless defined otherwise, all technical and scientific terms used herein have the same meaning as commonly understood to one of ordinary skill in the art to which this invention belongs. It should be appreciated that the term “substantially” is synonymous with terms such as “nearly”, “very nearly”, “about”, “approximately”, “around”, “bordering on”, “close to”, “essentially”, “in the neighborhood of”, “in the vicinity of”, etc., and such terms may be used interchangeably as appearing in the specification and claims. It should be appreciated that the term “proximate” is synonymous with terms such as “nearby”, “close”, “adjacent”, “neighboring”, “immediate”, “adjoining”, etc., and such terms may be used interchangeably as appearing in the specification and claims.

“Dielectric constant,” also known as “relative permittivity,” abbreviated as “Er,” as used herein, refers broadly to the permittivity expressed as a ratio relative to the vacuum permittivity. Permittivity is a material property that affects the Coulomb force between two point charges in the material.

### Luneburg Lens for Beamforming & Beam-Steering

A high-gain, wide-angle, multi-beam, multi-frequency beamforming lens antenna comprising a Luneburg lens with at least one planar interface in the southern hemisphere of the Luneburg lens and a planar ultrawideband modular antenna (PUMA array) structure. The PUMA array structure is connected to at least one of the planar interfaces of the Luneburg lens and is configured to function as a feed network to illuminate cells of the Luneburg lens simultaneously. The antenna is connected between multiple networks operating at different frequencies. A method to design and build non-concentric gradient-index (GRIN) dielectric structure is described. A method to build an anti-reflective layer enabled modified Luneburg lens antenna using non-concentric dielectric shells is presented. The method utilizes non-concentric spherical shaped dielectric structures to build a modified Luneburg lens and incorporated with an anti-reflective layer at the bottom. The anti-reflective layer is built by using several non-concentric cylindrical shaped dielectric shells. The process could be extended to other non-uniform Luneburg and stepped gradient lenses.

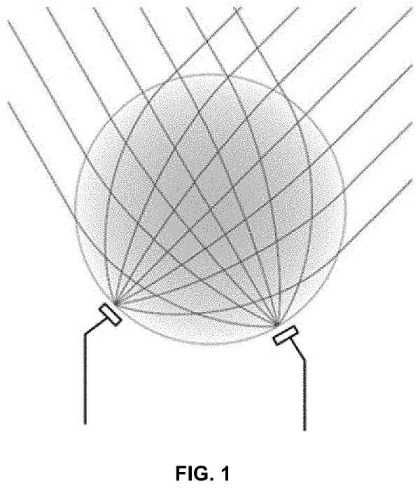

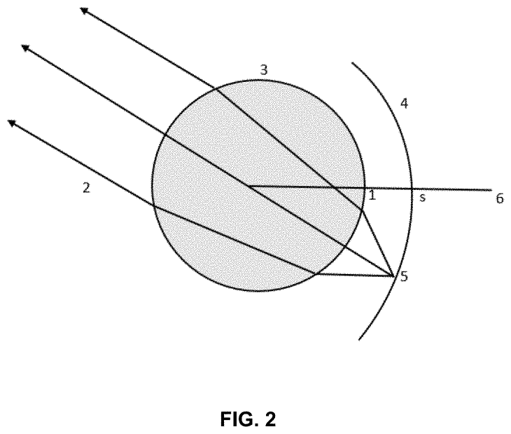

FIG. 1 and FIG. 2 illustrate Luneburg lenses. In reference to FIG. 2, a Luneburg lens 3 having a surface 1, shows the columnated electromagnetic waves emanating from the lens 2 with the focal sphere 4 locating the focal points for the lens and the point source 5 as the ideal point source located on the focal sphere. 6 shows the normalized radial distance from the lens.

FIG. 2 shows a generalized Luneburg lens with a focal point outside the lens. The focal point 5 is on an imaginary sphere 4 surrounding the lens. For a Luneburg lens, the focal point can be outside the surface of the lens as shown in this figure, or it can be on the surface of the lens as shown in FIG. 1. Due to the inherent property of essentially infinite focal points, a Luneburg Lens is an attractive option for an antenna because it can focus on radio waves emanating from any direction.

From a practical standpoint, there are three characteristics of a real lens that present challenges. Since the lens is spherical, the feeds must somehow be attached to the outside of a round structure. Though not an impossible task, this will require an elaborate three-dimensional structure to be created to support these feed assemblages. This most often involves a manual process or a complex automated process to assemble and align the structure. For traditional feeds such as horn and patch antennas, the lens structure presents a radio frequency (RF) impedance to the feed. In order to match the feed to the structure, an RF matching network must be designed in order to achieve acceptable performance when the feed is mated to the antenna. Both RF matching networks and traditional feeds tend to be limited in bandwidth. If constructed properly, the lens itself is broadband, but the resulting antenna assembly is narrowband due to the limitations of the feed and the match. Since the dielectric is non-uniform, it is not a simple process to manufacture the lens. Approximations of Luneburg lenses are made using layers of dielectric materials with varying dielectric constants, however making a lens with a continuously varying dielectric constant has been elusive.

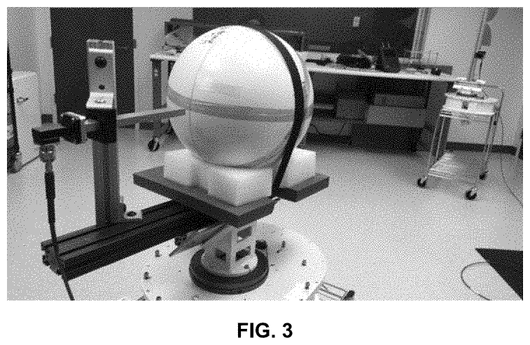

FIG. 3 is an example of a particular implementation of Luneburg lens.

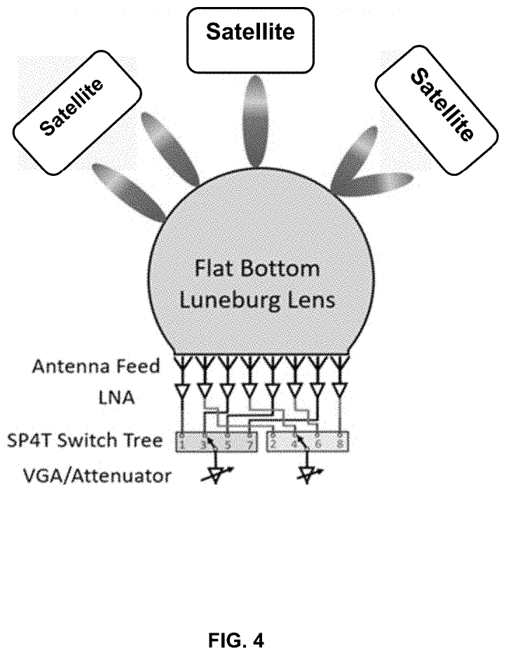

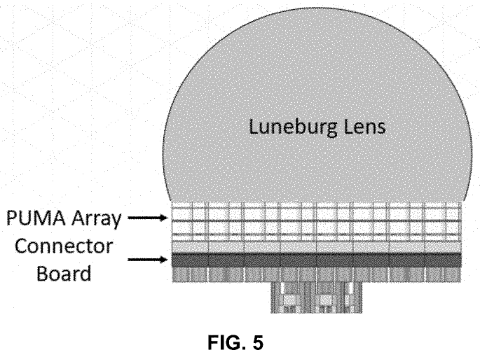

FIG. 4 and FIG. 5 illustrate the modified Luneburg lens. FIG. 4 depicts a modified Luneburg lens coupled to an array of antenna feeds and beam switching circuitry.

FIG. 5 depicts a flattened Luneburg lens coupled to a PUMA array coupled to a connector board. See, e.g., U.S. Pat. No. 8,325,093; U.S. Patent Application Publication No. 2012/0146869 for description of a PUMA array.

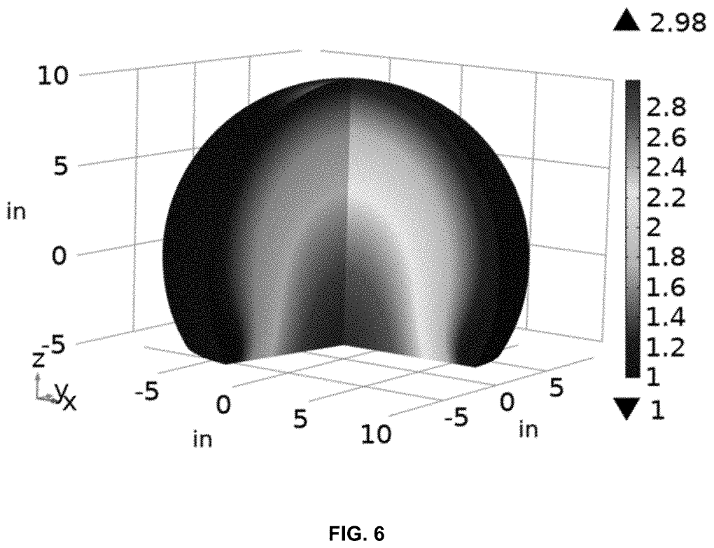

The problem of having to feed the lens with a circular (non-planar) feed arrangement was solved by using TO mathematics to transform the feed surface from one that is round to one that is flat (planar). Manufacturing a flat (planar) feed structure is poorly accomplished using currently available printed circuit board development techniques. The problem of manufacturing the continuously-varying dielectric lens was solved by using additive manufacturing (also known as three-dimensional (3D) printing) to create a structure with a non-homogenous dielectric constant. This was accomplished by using the additive manufacturing process to create a structure that incorporates small air gaps of varying size within the dielectric material. If the air gaps and the dielectric structure are small with respect to the wavelength of the desired signal, the structure approximates a dielectric constant of 1.0. If the dielectric constant of the structure material is 3.0, the range of possible dielectric constants in the structure can vary from 3.0 (no air pockets) to close to 1.0 (very small amounts of dielectric material with mostly air gaps). The printing process builds the structure with small individual blocks called cells and allows the dielectric constant to be varied on a cell-by-cell basis. The cells can be very small with respect to the wavelength of the signal, so good granularity in the gradient of the dielectric constant is achievable. FIG. 6 illustrates 3D the modified Luneburg lens permittivity distribution.

A problem with Luneburg lenses is the match between the feed and the lens. Instead of attaching the feed directly to the lens, which has a varying match to the feed as you go from center to the edge of the flat part of the structure, an interface layer (referred to as an ‘anti-reflective layer’) was inserted between the feed and the modified lens. This layer is analogous to a matching network in an RF circuit—it is designed so that a good match between the feed and the lens is obtained across the entire interface surface. Additionally, this layer can be designed to be as broadband as needed, so limited bandwidth is not a significant problem.

Luneburg Lens Architecture Comprising Planar Surfaces

The Luneburg lens described herein can comprise planar surfaces.

The Luneburg lens described herein can comprise an upper hemisphere and a lower hemisphere. The upper hemisphere can comprise a spherical Luneburg lens. The lower hemisphere can comprise a plurality of geometrical interfaces, e.g., planar surfaces, arranged around the outer surface of the Luneburg lens in a southern hemisphere of the Luneburg lens. The Luneburg lens described herein can comprise a substantially planar bottom.

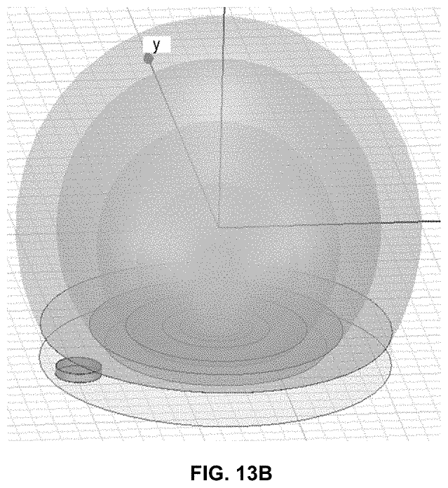

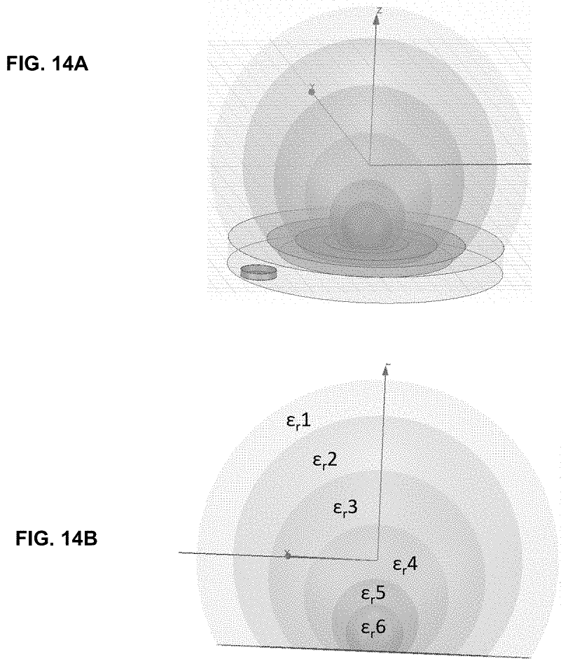

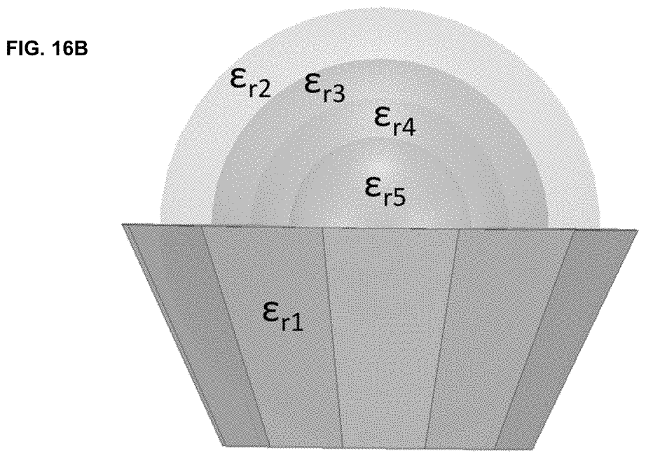

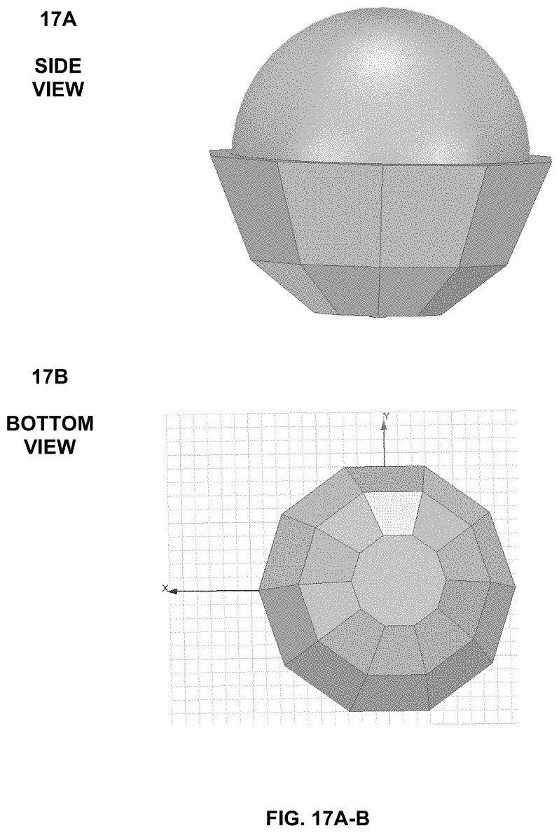

The sets of pluralities of geometrical interfaces at a side of the Luneburg lens in a southern hemisphere of the Luneburg lens extending around of the Luneburg lens may be arranged at an angle. FIG. 12 A-B (depicting PUMA arrays configured on the planar surfaces), FIG. 16A-B and FIG. 17A-B. The angle, as measured between the bottom and the planar surface, may be between 0° and 90°. The angle may be between about 30° and 60° degrees. The angle may be between about 30° and 40°, 10° and 90°, 50° and 60°, 35° and 55°, 60° and 90°, or 35° and 50°. The angle may be about 0°, 1°, 2°, 3°, 4°, 5°, 6°, 7°, 8°, 9°, 10°, 11°, 12°, 13°, 14°, 15°, 16°, 17°, 18°, 19°, 20°, 21°, 22°, 23°, 24°, 25°, 26°, 27°, 28°, 29°, 30°, 31°, 32°, 33°, 34°, 35°, 36°, 37°, 38°, 39°, 40°, 41°, 42°, 43°, 44°, 45°, 46°, 47°, 48°, 49°, 50°, 51°, 52°, 53°, 54°, 55°, 56°, 57°, 58°, 59°, 60°, 61°, 62°, 63°, 64°, 65°, 66°, 67°, 68°, 69°, 70°, 71°, 72°, 73°, 74°, 75°, 76°, 77°, 78°, 79°, 80°, 81°, 82°, 83°, 84°, 85°, 86°, 87°, 88°, 89° or 90°. In Luneburg lens with multiple sets of geometric interfaces, the angle may be measured with respect to the bottom for the first set and at the juncture between the first and second set of geometric interfaces. All additional sets of geometric interfaces may be measured between at the intersection of two sets of geometric interfaces.

The sets of pluralities of geometrical interfaces comprise 2, 3, 4, 5, or 6 sets of pluralities of geometrical interfaces. The sets of pluralities of geometrical interfaces comprise 2 sets of pluralities of geometrical interfaces. The pluralities of geometrical interfaces are substantially planar. The pluralities of geometric interfaces may be planar (e.g., flat). For example, the geometrical interfaces may be trapezoidal-shaped flat surfaces.

The pluralities of geometrical interfaces comprise between about 4 and 20 geometrical interfaces in each set. The pluralities of geometrical interfaces comprise between about 4, 5, 6, 7, 8, 9, 10, 11, 12, 13, 14, 15, 16, 17, 18, 19, or 20 geometrical interfaces in each set. For example, FIGS. 17A and 17B illustrate two (2) sets of ten (10) geometric interfaces.

The pluralities of geometrical interfaces have a near-air dielectric constant. For example, the dielectric constant may be about 1.00058986. The dielectric constant may be about 1.1.

The pluralities of geometrical interfaces comprise an anti-reflective layer.

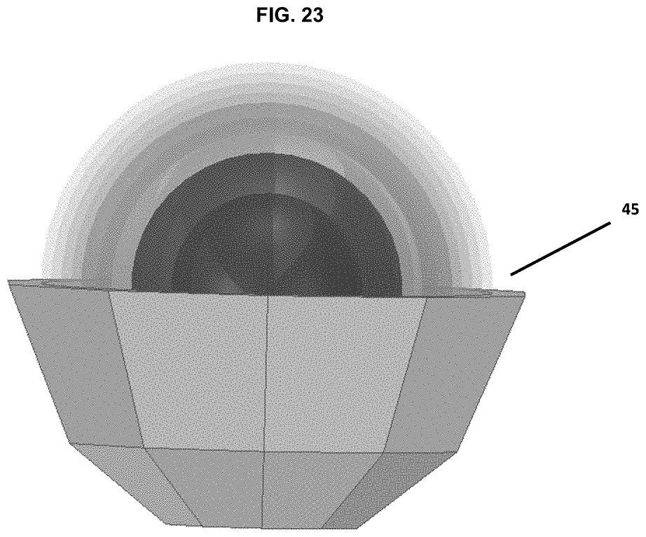

In reference to FIG. 23, the Luneburg lens antenna can comprise a ledge at the top of the lower hemisphere (“cupcake shaped” cup). For example, there may be a space between the edge of the geometric interfaces comprising the lower hemisphere and the spherical Luneburg lens comprising the upper hemisphere, e.g., a ledge. The ledge offers several advantages over existing antenna. For example, the planar surface of the ledge helps to integrate the feed elements conveniently as most of the feed elements (e.g., PUMA) are planar. The ledge gives the antenna a horizon to horizon beamscanning capability (±90°) which allows the antenna to track any satellite in the sky without loosing any connection. This is in contrast with existing antenna which have limited beamscanning capability. The lens described herein eliminates that problem. The lens described herein also offers very high gain and efficiencies which will help to meet the G/T requirements in satellite communication. This shape of lens described herein is more easily realizable with standard manufacturing method and materials.

The Luneburg lens can comprise an upper hemisphere and lower hemisphere. The upper hemisphere can comprise a Luneburg lens, e.g., spherical in shape. The Luneburg lens may be discretized or continuous. The lower hemisphere can comprise a set of substantially planar surfaces and a substantially planar bottom. In this embodiment, the Luneburg lens can comprise between about 4 and 20 planar surfaces. In reference to FIG. 12A, the Luneburg lens may be configured to interface multiple ultra-wideband arrays, e.g., PUMA, to the Luneburg lens. In reference to FIG. 12B, the Luneburg lens may have a plurality of ultra-wideband arrays, e.g., PUMA, configured on the bottom of the Luneburg lens. For example, multiple ultra-wideband array, e.g., PUMA, may be connected to multiple flattened surfaces of the Luneburg lens. The PUMAs connected at several angles allow for full hemispherical coverage of the sky. FIGS. 12A and 12B illustrate the PUMAs connected to the Luneburg lens on the planar surfaces and planar bottom.

In reference to FIG. 16A-B, a continuous dielectric Luneburg lens (A) and a discretized dielectric cupcake-shaped lens (B) each comprising a spherical upper hemisphere and a lower hemisphere comprising a set of sequential geometric surfaces, e.g., planar, and a planar bottom. The Luneburg lens can comprise a single set of between about 4 and 20 planar surfaces. Here, a Luneburg lens with 10 planar surfaces is shown.

Each layer and side of the Luneburg lens with a pyramidal base (“cupcake shape”) may have a dielectric constant (εᵣ) value, that may be the same or different from other dielectric constant (εᵣ) value. Each layer and side of the Luneburg lens with a pyramidal base (“cupcake shape”) may have a dielectric constant (εᵣ) value, that may be different from other dielectric constant (εᵣ) value. For example, the planar surfaces may have a dielectric constant (εᵣ) value, Ea, and, for a discretized Luneburg lens (shown in FIG. 16B), each layer of the discretized Luneburg lens may have an independent dielectric constant (εᵣ) value, e.g., εᵣ1, εᵣ2, εᵣ³, εᵣ4, εᵣ5. The dielectric constant (εᵣ) values may be the same or different. The dielectric constant (εᵣ) values may be different. For example, in FIG. 16B, the upper hemisphere may have a dielectric constant (εᵣ) value of 2 at the center and a dielectric constant (εᵣ) value of about 1 at the edge.

The bottom hemisphere of the modified Luneburg lens may have a flat bottom with a series of planar sections (“cupcake shape”). At least one planar interface in the lower hemisphere of the cupcake-shaped Luneburg lens, continuous or discretized, may be coupled to a planar ultrawideband modular antenna (PUMA) array structure. The PUMA array structure may be connected to at least one of the planar interfaces of the Luneburg lens and is configured to function as a feed network to illuminate cells of the Luneburg lens simultaneously. The planar interferences in the lower hemisphere of the truncated pyramidal (cupcake-shaped) Luneburg lens, continuous or discretized, may be coupled to an anti-reflective layer, which may be a discretized anti-reflective layer.

In reference to FIG. 17A-B, this drawing depicts a Luneburg lens with two sets of substantially planar sections extending around the perimeter of the Luneburg lens. The substantially planar sections may be electronically coupled to the Luneburg lens. The Luneburg lens can comprise between about 1 and 20 substantially planar interfaces in each set, optionally about 10 substantially planar interfaces, and can comprise at least one or two sets of substantially planar interfaces. The sets of substantially planar interfaces may be arranged at an angle, relative to a horizontal plane intersecting the central axis, e.g., relative to the substantially planar bottom. The angle between The Luneburg lens depicted in FIG. 17A-B has a substantially planar bottom, e.g., at the bottom of the southern hemisphere. The angle may be between about 0° and 90°, optionally at about 30° to about 60°. In one embodiment, there is a ledge between the Luneburg lens and the substantially planar interfaces. The ledge may be between about 1 mm and 1,000 mm, 1 cm and 1,000 cm, or 1 meter and 2 meters. For example, the ledge may be about 1 meter or about 2 meters. The Luneburg lens may be between about 5 mm and 5 M in diameter in size. The Luneburg lens may be a continuous dielectric lens or a discretized dielectric lens. FIG. 17A is a side view and FIG. 17B is a bottom view.

The Luneburg lens can also be manufactured using fused deposition modeling (FDM) or polymer resin-based 3D printing method. In the 3D printing case, the dielectric values are realized by changing the volume fraction of the base material using different sized air holes.

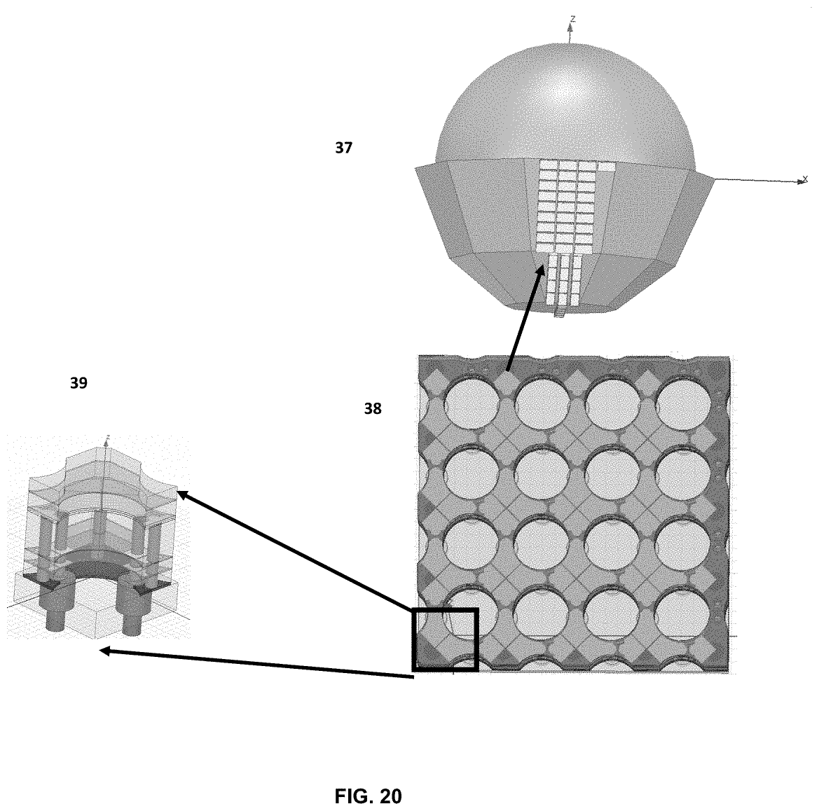

In reference to FIG. 20, a Luneburg lens antenna 37 as described herein may be excited by a plurality of feed sources 38 configured along each of the planar surfaces. The flattened sides of the lower hemisphere may be populated with sufficient feed sources to achieve a horizon-to-horizon beamscanning capability. The feed source may be a waveguide, PUMA antenna array (e.g., 4×4, 8×8), Horn antenna array, charged coupled device (CCD), other EM feed source, or a combination thereof 39 depicts a single PUMA element. In an embodiment, the Luneburg lens may have multiple flattened sides. For example, the Luneburg lens may have 1, 2, 3, 4, 5, 6, 7, 8, 9, 10, 11, or 12 flattened sides. Instead of a spherical shape, the Luneburg lens may have, for example, an octahedron (e.g., 8 flattened sides), pentagonal trapezohedron (e.g., 10 flattened sides), dodecahedron (e.g., 12 flattened sides), or an icosahedron shape (e.g., 20 flattened sides).

The Luneburg lens antenna may have multiple beams and to switch between the beams, the feed excitation needs to be changes sequentially using the back-end electronics as shown in the figure. This allows switching between the beams created by each of the feed elements by using the back-end beamswitching electronics. The beam switching network design may be of a different architecture. In this embodiment, a Luneburg lens comprising discrete lens shells, and a bottom portion comprising two sets of substantially planar interfaces and a substantially planar bottom, comprising a plurality of waveguide arrays placed coupled to each of the planar surface. The Luneburg lens receives multiple simultaneous beams via Antenna feed elements. A number of antenna feed elements (M) may be disposed around the outside of the Luneburg lens described herein, electronically coupled to feed arrays electrically coupled to a beam switching network. In this configuration, the Luneburg (Luneburg) lens antenna and feed arrays coupled to a beam switching network. Each feed element is coupled to a low noise amplifier (LNA) to increase the received signal's gain value. An array of LNAs is connected through a network of switching matrix which are connected to the power source via a Wilkinson power divider network, for example. Using the switch matrix, any antenna port receiving a signal can be connected within a microsecond.

The Luneburg lens described herein comprising discrete lens shells, and a bottom portion comprising two sets of substantially planar surfaces and a substantially planar bottom. The Luneburg lens described herein comprises a ledge between the spherical upper hemisphere and the geometric panels in the lower hemisphere. The lower hemisphere is shown as semi-transparent to depict Feed sources on the opposite side of the Luneburg lens. The feed sources may be arranged parallel with or perpendicular to the X axis of the Luneburg lens antenna. The Luneburg lens described herein comprises a ledge between the spherical upper hemisphere and the geometric panels in the lower hemisphere.

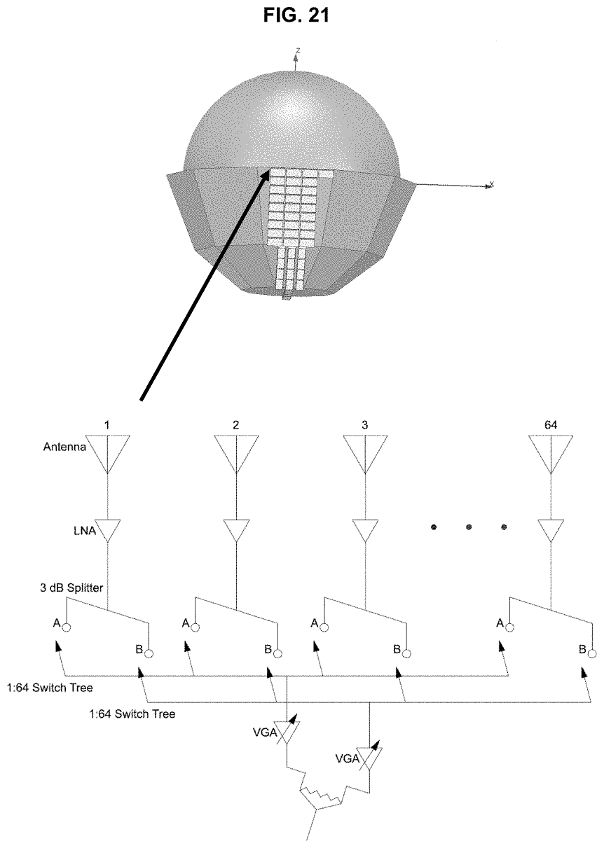

In reference to FIG. 21, depicts an exemplary beam switching network, for example, for 8×8 feed arrays. In this embodiment, 40 depicts a Luneburg lens, optionally comprising discrete lens shells, and a bottom portion comprising two sets of substantially planar interfaces and a substantially planar bottom, comprising a plurality of feed elements placed coupled to each of the planar surface. The Luneburg lens 40 has a plurality of feed elements 44, optionally arranged in arrays, disposed around the outside of the Luneburg lens described herein, coupled to the low-noise amplifiers (LNA) to increase the received signal's strength. Then, an array of LNA connected feed elements are connected to a switch matrix to switch between multiple beams, optionally arbitrarily switch between multiple beams.

In reference to FIG. 23, an exemplary Luneburg lens antenna described herein can comprise discrete lens shells, and a bottom portion comprising two sets of substantially planar interfaces and a substantially planar bottom. A plurality of waveguide arrays may be electronically coupled to each of the planar surface. In this embodiment, the two sets of substantially planar surfaces are different sizes, e.g., the top set is larger than the bottom set. In other embodiments, the two sets of substantially planar surfaces may be about the same size. The Luneburg lens described herein may be manufactured using layered shell approach where spherical portion is manufactured in multiple layers. Each layer may have a different dielectric value. The outer layer (cupcake structure) can be manufactured by machining a lower-dielectric material into the desired shape. Finally, all the layers are packed together using an adhesive material. In a different embodiment, the Luneburg lens described herein is manufacturing using a 3D printing method where the entire Luneburg lens is manufactured using fused deposition modeling (FDM) or polymer resin-based 3D printing method. In the 3D printing method, the dielectric values may be realized by changing the volume fraction of the base material using different sized air holes.

### Manufacturing Method for Discretized Luneburg Lens and Systems Comprising the Same

This disclosure describes a method to design and produce a low-cost, multi-beam, multiband electronically steerable lens antenna for terrestrial wireless, satellite, and radar applications. The methods described herein achieve technical advantages by using a method to manufacture a lens with a discretized dielectric profile by assembling layers of different constant dielectric materials. Present methods for manufacturing non-spherical dielectric graded antennas involve a slow and machine-intensive process whereby dielectric material is slowly and precisely added using additive manufacturing techniques. The result is that even a small to moderate sized antenna lens can take weeks or months to produce, and if there are any glitches in the process, the whole process must be started over.

The process described herein relies on a concept that a non-spherical graded dielectric can be approximated using layers of constant dielectric material. A classic Luneburg lens has a continuously varying dielectric. For a classic Luneburg lens, this continuously varying dielectric can be emulated using steps of constant dielectric materials. The systems and methods of manufacture of modified Luneburg lenses, including those with an antireflective layer, and other non-uniform lens structures, using a discretized dielectric process are described herein.

In methods described herein, the individual layers can either be cast in a mold, machined from a solid piece of material, or made using an additive manufacturing process. The individual layers are then assembled into a complete antenna. Using computer aided design to optimize the discretized layers, this process yields an antenna with excellent RF performance while allowing an antenna to be manufactured start-to-finish in a day or less, and without requiring an expensive precision 3D printing machine.

For example, a lens antenna created using the traditional additive manufacturing requires a precision additive manufacturing machine that builds up very fine layers of precision-placed material. Since the material is placed in fine layers in a precise fashion, the process requires an expensive machine, and it is a lengthy process. A lens on the order of 10 inches can take 6 to 8 weeks using a dedicated machine costing hundreds of thousands of dollars. This is not conducive to manufacturing lenses except for the most exotic applications.

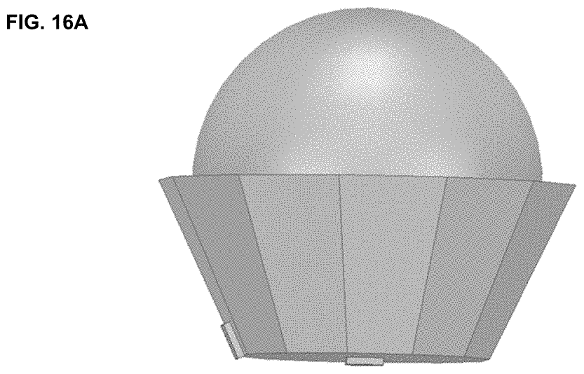

In contrast, for the manufacture of a discretized Luneburg lens as described herein, each of the layers is cast individually, then they are nested together and assembled using an adhesive. See FIG. 15. The layers shown in FIG. 15 are nested but not completely aligned to give a better view of the manufacturing process. Using this method, each layer is cast in an individual mold or made using a subtractive manufacturing process (machining), allowing the different layers to be made in parallel. A material suitable for molding may be a two-part poured resin and an adhesive may be a two-part epoxy. For machined parts, materials such as Delrin® (polyoxymethylene POM) or Lexan® (polycarbonate) can be used.

The material used in the system and methods described herein may be a fast-setting resin material which cures in a period of hours to overnight. Materials such as Ryton® (Poly(p-phenylene sulfide) polymer), Polystyrene and Polyurethane can be used for casting.

The dielectric constant of the resin is varied from layer to layer by varying the chemical composition. If special material properties are needed, some of the layers can also be machined (subtractive manufacturing) from solid pieces of material.

The inventors explored a new technological approach that seemed to be a promising field of experimentation, but the technical information in the art only gave general guidance as to the particular form of the system and methods described herein or how to achieve it. In contrast with existing approaches, the inventors first designed a modified Luneburg lens using transformational optics, transformed the design to a discretized design, then manufactured that lens utilizing the layered dielectric approach to obtain an antenna showing an unexpected improvement in performance. The inventors adapted the process for modified Luneburg lenses, including an anti-reflective layer. The techniques described herein can be extended to other similar antennas designed using transformational optics. Once designed, all of the sections can be made in parallel, reducing manufacturing time, and then assembled to make the final lens.

In contrast, lenses designed using transformational optics are customarily manufactured using additive manufacturing. This additive manufacturing process is lengthy, expensive, and prone to manufacturing errors, and potentially yields a lens that is susceptible to damage from shock and vibration. An example of an additive manufacturing process is Fused Deposition Modeling (FDM) whereby solid material is melted, extruded through a nozzle, then deposition layer by layer to create a 3-dimensional object. In order to achieve precision, small nozzles must be used and they must deposit the material slowly. For a graded dielectric lens, this entails creating layers of intricate structures, alternating between material and air gaps, to achieve the desired electrical properties. To achieve the needed precision at the scales required, a typical lens can take weeks to print using a very expensive precision machine. If there is an error anywhere in the process, the entire assemble may need to be scrapped. The system and methods described herein eliminates this problem, resulting in a more cost-effective, rapid, and efficient method of producing a better lens for antenna systems.

The inventors developed an efficient method of the manufacture of Luneburg radiofrequency (RF) structures using resin casting and machining of dielectric materials to the manufacture of a class of radiofrequency (RF) lenses, namely modified Luneburg Lenses designed using transformational optics.

The method can comprise the following steps: A modified Luneburg lens is designed with a continuously variable dielectric constant, potentially including an anti-reflective layer, using transformational optic (TO) techniques. This TO lens design is modified to have discretized layers. This transformation from a continuously variable dielectric to a discretized dielectric. The discretized modified Luneburg lens and antireflective layer are fabricated using non-concentric dielectric ‘shells’. These individual shells can be manufactured using one of three techniques, or any combination of the three: (a) Resin casting—a liquid resin is formulated and poured into a mold of the desired shape; (b) Subtractive manufacturing of a solid dielectric—the desired shape is subtractive manufactured (machined) from a solid piece of material having the appropriate dielectric properties; (c) Additive manufacturing—an additive manufacturing process is used to create one or more of the shells; or (d) a combination thereof. Once the individual shells or layers are manufactured, the individual shells are assembled together to form an antenna assembly.

Exemplary advantages of the systems and methods described herein over known processes are: (a) Faster manufacturing—instead of taking weeks or months to manufacture an antenna, an antenna can be completed in a period of hours to days; (b) Reduced need for expensive machinery—expensive machinery, such as a 3D printer, is not needed for this process; (c) Lower cost—because of the faster manufacturing time and not needing expensive machinery, the cost is lower; (d) Increased manufacturing capacity—since expensive machinery is not needed, more molds and tooling can easily be made to make more lenses in parallel; (e) Larger antennas—using this process, it will be possible to make larger antennas (up to 1 meter or larger), which is beyond the capability of current additive manufacturing processes; and (f) combinations thereof.

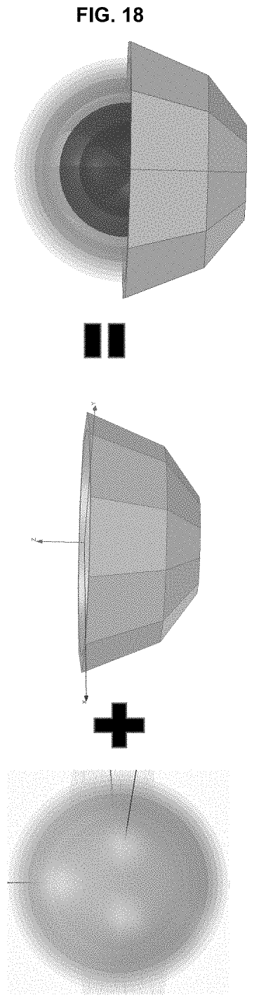

The Luneburg lens described herein may be manufactured in at least two different ways. In a first approach, in reference to FIG. 18, a Luneburg lens, optionally a continuous dielectric or discretized lens, may be manufactured using methods described herein or known in the art. The “cupcake shaped” cup may be manufactured using methods described herein. The Luneburg lens and “cupcake shaped” cup may then be combined and affixed using adhesives suitable for antennas. Anti-reflective coatings may also be added to the Luneburg lens, the “cupcake shaped” cup, or both. As described herein, the “cupcake shaped” cup may form the structure in the lower hemisphere of the Luneburg lens antenna, comprising at least two sets of substantially planar geometric interfaces and a substantially planar bottom. The substantially planar geometric interfaces may be planar (e.g., flat). In the finished Luneburg lens architecture in FIG. 18, by using lower dielectric material for the “cupcake shaped” cup than the Luneburg lens, the dielectric value may change from 2 (at the center) to 1 (at the edge).

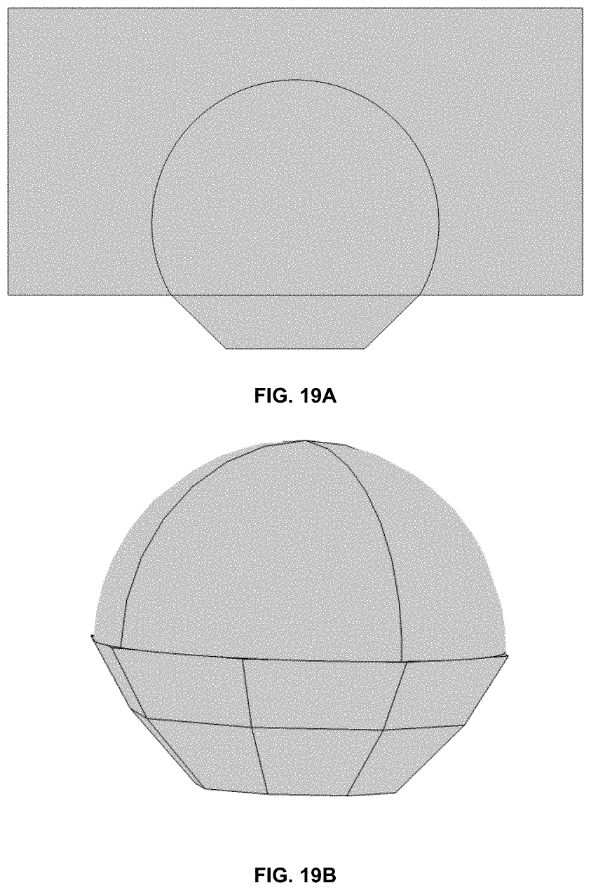

In a second approach, in reference to FIG. 19A, a 2D version of the spherical Luneburg lens is modified into a “cupcake” structure (as shown in figure) by solving the Laplace equation, and the dielectric profile of the modified 2D lens is calculated utilizing quasi-conformal transformation optics (QCTO) technique. The 3D version of the modified lens is designed by axisymetrically rotating the 2D design. In reference to FIG. 19B, the axisymetrically rotated 3D design will have a spherical surface at the sides, and to achieve flat surface at the sides, the lens is then transformed into a cupcake shape by eliminating some portions of the lens surface. To minimize any reflections at the sides, broadband anti-reflective layers are designed and embedded at each of flat surface of the cupcake lens. Figure below shows the final architecture of the 3D cupcake lens designed with transformation optics.

### Ultrawideband (UWB) Array Antenna Structure

Several different instantiations of flat panel and phased array antennas are known. An ongoing challenge with these antennas has been to develop an antenna that is both ultra-wideband (UWB) and easily manufactured. There exist antennas that are wideband but not easily manufactured (such as the Vivaldi array) and there are many different flat panel antennas that are easily manufactured but which only operate over one or two frequency bands.

An antenna called the Planar Ultra-wideband modular antenna (PUMA) is both wideband (6:1 bandwidth) which is also manufactured using standard Printed Circuit Board (PCB) processes by board houses using standard materials such as Rogers 3000 and 6000.

UWB antennas such as the PUMA have the following properties that make them useful for SATCOM and terrestrial microwave communications: They can be manufactured by different PCB board houses using standard PCB processes. They can be made to operate UWB (6:1 bandwidth ratios are common). They retain good cross-polarization and gain performance up to 60 degrees scanned off-axis from boresite.

The structure of the PUMA array comprises a PUMA unit cell, which is used as a feed for a modified Luneburg lens including the top dielectric superstrate (εᵣ₁) bonding and dielectric layers (εᵣ₁), PUMA feed vias, ground plane, input port, dipole arm, cross section of feeds and feed dielectric, inner dielectric layers (εᵣ₀) and (εᵣ₃), plated vias, and coaxial connector. The PUMA unit cell comprises a trace layer. The spacing of the trace layer above the ground plane and the thickness and chosen material of the dielectric layers determines the frequency, bandwidth, and performance of this class of antennas.

### Connecting the Lens to the Array

The modified UWB Luneburg Lens provides the following benefits, among others: Modified optics allow for a flat-faced feed interface, Optics are inherently very wideband, These can now be manufactured using currently-available additive manufacturing techniques, The shape of the lens inherently supports very wide-angle coverage (up to +/−60 degrees off boresite in a semi-hemispherical coverage pattern), and the lens is inherently efficient (efficiencies of 70% or greater—on par with parabolic reflectors).

The UWB antenna class, including but not limited to a PUMA, provides the following benefits: Extremely wideband (6:1 bandwidth ratio) operation with directive signals, Excellent off-axis performance up to +/−60 degrees off boresite in a semi-hemispherical coverage pattern, and manufactured using standard PBC fabrication techniques.

The Luneburg lens described herein constitute a class of UWB Luneburg Lenses that provide a planar (flat) interface in the southern hemisphere of the lens to which an array can be mated and connect that to an UWB planar array such as the PUMA. Further, the discretized Luneburg lens described herein may be used. The inventors created a class of UWB lens antennas that utilizes a UWB array such as a PUMA as a feed network to illuminate several cells of the Modified Luneburg Lens simultaneously, including discretized Luneburg lens described herein.

This class of UWB lens antennas has, among others, the following properties:
(a) Wideband frequency coverage (6:1 bandwidth ratio) allowing for operation in multiple frequency bands simultaneously;
(b) Multiple simultaneous beams (potentially complete sky coverage with enough beams illuminated simultaneously);
(c) Wide area sky coverage (up to a full-hemispherical pattern);
(d) No moving parts required to operate; and
(e) Excellent efficiency relative to other directive antenna solutions (such as parabolic reflectors)

### A Flat Interface Between the Modified Luneburg Lens and the UWB Antenna

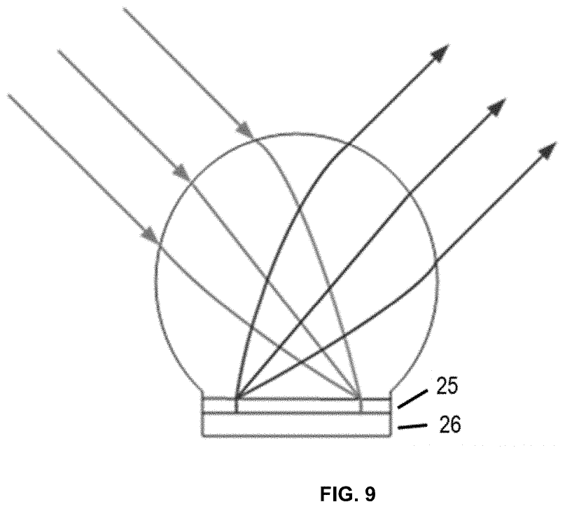

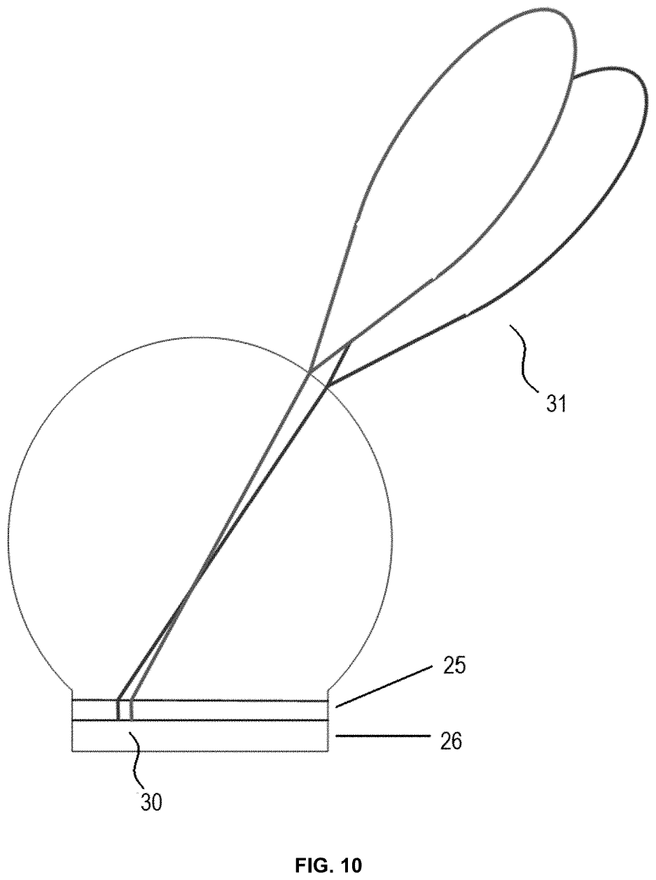

FIG. 8A is graphs showing return loss performance of the PUMA feed array at specific frequencies and FIG. 8B is a graph showing the simulated return loss performance at different angles. The plots of the graphs show that this design allows for an extremely broadband transmission and reception of signal in a bandwidth ratio of 4-to-1, meaning that the antenna can operate in multiple microwave frequency bands simultaneously. This allows a single antenna to operate on a multitude of networks such as cellular, microwave, terrestrial and satellite networks. Doing so allows users to minimize the number of purpose-built antennas that are used for signal communications. The bandwidth ratios for the systems described herein can be 3:1, 4:1, 5:1, or 6:1. The bandwidth ration for the systems described herein can be 4:1.

The designs described herein allows for a multitude of signals to be transmitted and received simultaneously in multiple directions. By itself, the PUMA array can transmit signals in a single direction, however connecting the PUMA to the Luneburg lens we change the way the PUMA is used. Instead of an array of signals being transmitted and received through all of the ports simultaneously creating the gain, only 4 adjacent signals are sent through one port at a time, which then is directed in a specific direction through the Luneburg Lens.

The designs described herein also allow for a multitude of signals to be transmitted and received simultaneously in multiple directions in multiple frequency bands as well. This means that the single antenna can connect between multiple networks operating at different frequencies, which was not possible using existing systems.

The designs described herein require no moving parts for the antenna, as the Luneburg lens is a static beamformer that does not need to move in order to aim the signal in the desired direction. Unlike mechanical antenna systems, this design will have a much longer life cycle as there are no active components, and passive components tend to have much longer life cycles. Furthermore, unlike other antennas, such as active electronic steered array (AESA) antennas, that do not have moving parts, this antenna does not require a tremendous amount of power, as the beamforming is done in the passive Luneburg Lens element as opposed to digital beamformers that require a tremendous amount of power. The power savings for the systems described herein over a typical AESA antenna is 80%.

The antennas described herein have excellent efficiency (as high as 90%, for example about 80% or between about 70% and 80%) and high gain properties when compared to other directional antennas such as parabolic antennas (60% typical). This allows for smaller antennas to be used than would be possible with a parabolic antenna. Furthermore, when compared to an AESA antenna, the antenna design described herein requires less surface area for the same amount of gain as the Luneburg lens operates as the beamformer and the transmitter and receiver are closer to the desired signal than would be in a traditional AESA architecture.

The flat interface between the PUMA and the Luneburg Lens allows for a connection between two devices that would not have been possible before, as a traditional Luneburg lens would be completely spherical, and a PUMA is a planar array of feed assemblies. By adjusting the positioning of the flattened assemblies we can increase or decrease the illumination (gain) in certain directions, and it is possible to increase the scan area of the antenna to full hemispherical coverage (360 degrees azimuth, +/−90 degrees elevation). The focal point may be adjusted by adjusting the thickness of the outer layer. For example, the focal point may be determined during the design process and implemented during the manufacturing process.

Another embodiment of the antenna design described herein includes multiple flat interfaces at varying geometries will allow for full hemispherical coverage. For example, it is possible to increase the scan area of the antenna to near full hemispherical coverage (360 deg azimuth, +/−80 degrees elevation).

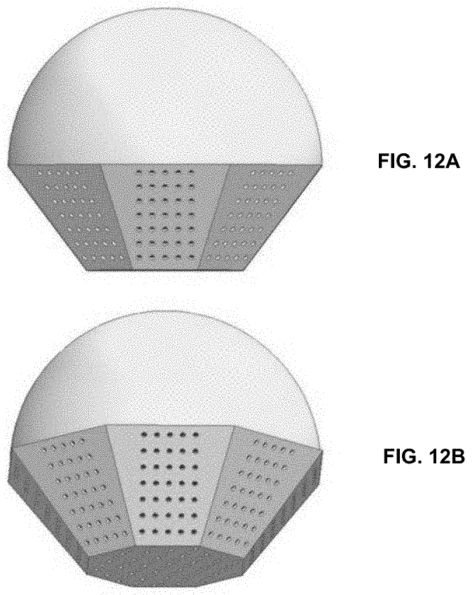

A high-level diagram of an exemplary lens antenna system is shown in FIG. 10. The figure shows a modified Luneburg lens fed by a PUMA array structure with an anti-reflective layer to provide a broadband match and to marry the two structures. In an embodiment, a modified Luneburg lens fed by a PUMA array structure with a quarter-length long anti-reflective layer to provide a broadband match and to marry the two structures.

The PUMA array structure including feeds and coax connectors. This arrangement allows connection to other components of the radio assembly including the point where the coaxial feed structure is connected to the PUMA array, the copper dipole layer (Dipole layer Duroid), and loaded via a capacitive loading screw.

In a traditional UWB antenna such as a PUMA, the elements are spaced at one-half the wavelength at the highest frequency (λ/2). This is because the UWB antenna traditionally phase-combines multiple elements to create a phased array of antennas. In one configuration, the antenna is using one (or a small number of) feed element(s) to drive a single beam of energy. The UWB antenna comprising the modified Luneburg lens, including discretized modified Luneburg lens described herein, differs from the existing instantiations, at least, as follows.

The element location is dictated not by phased array formulas but instead by the location of the beams. Because of this, the elements will not necessarily be spaced at λ/2, and elements will not necessarily be evenly spaced, but instead match the appropriate mapping of the modified Luneburg lens to cover a cell of area that translates to a specific direction out of the lens. In the traditional UWB antenna, adjacent elements interact with one another and this interaction is integral to the operation of the UWB antenna in a phased array application. In the systems described herein, the elements can operate independently of adjacent elements, so the nature of the interaction between elements will be quite different.

In a traditional UWB antenna such as a PUMA, the top layer of the antenna is matched to air/free space. In this application, the UWB antenna structure will be matched to the lens via the anti-reflective layer. Because of this, the UWB antenna structure design could deviate quite significantly from the traditional UWB antennas at least as follows:

The top layer of dielectric in a UWB antenna design can be integrated into the anti-reflective layer, or it will be replaced entirely by the anti-reflective layer. There can be a single layer of material between the dipole layers of the UWB antenna and the modified Luneburg lens. This layer may be designed to provide good matching between the UWB antenna and the modified Luneburg lens.

The top layer of dielectric in a UWB antenna design can be integrated into a quarter-wave long matching layer, or it will be replaced entirely by a quarter-wave long matching layer. There may be a single layer of material between the dipole layers of the UWB antenna and the modified Luneburg lens. This layer can be designed to provide good matching between the UWB antenna and the modified Luneburg lens.

A continuous modified Luneburg lens may have a planar anti-reflective layer coupled to the top of the lens and the bottom of the lens. A discretized modified Luneburg lens may have a planar anti-reflective layer coupled to the top of the lens and the bottom of the lens.

A discretized flattened Luneburg lens can have a flat bottom and gradually shaped curved outside surface. The lens may be fabricated from multiple layers of material with different dielectric constants for realizing a gradient-index (GRIN) lens. The curves at the interfaces between the layers can be generalized. The interfaced sections can be non-concentric, or concentric ellipsoid sections.

Because the lens and the anti-reflective layer may not be homogenous across the interface surface, it is possible that, in addition to being spaced differently, the UWB antenna elements may have different designs at different points across the surface. The design criteria for the antenna is to have well-behaved gain both spatially and across frequency. Having the ability to optimize the design of the lens, the anti-reflective layer, and the individual feed elements maximizes the efficiency and bandwidth of the Luneburg lens described herein.

In an embodiment, the lens and the matching reflective layer may not be homogenous across the interface surface, it is possible that, in addition to being spaced differently, the UWB antenna elements may have different designs at different points across the surface. The design criteria for the antenna is to have well-behaved gain both spatially and across frequency. Having the ability to optimize the design of the lens, the anti-reflective layer, and the individual feed elements maximizes the efficiency and bandwidth of the Luneburg lens described herein.

The Luneburg lens antenna described herein may be configured to operate over a wide range of bandwidth for satellite frequencies, super high frequency (SHF), e.g., wavelength between about 10 cm and 1 cm. For example, the Luneburg lens antenna described herein may operate over a bandwidth between about 1 GHz and 40 GHz. For example, the Luneburg lens antenna may operate over a bandwidth between about 1 GHz and 2 GHz (L-band). The Luneburg lens antenna may operate over a bandwidth between about 2 GHz and 4 GHz (S-band). The Luneburg lens antenna may operate over a bandwidth between about 4 GHz and 8 GHz (C-band). The Luneburg lens antenna may operate over a bandwidth between about 8 GHz and 12 GHz (X-band). The Luneburg lens antenna may operate over a bandwidth between about 12 GHz and 18 GHz (Ku-band). The Luneburg lens antenna may operate over a bandwidth between about 26 GHz and 40 GHz (Ka-band).

An element of the design described herein is that the UWB antenna array does not function as a phased array. Rather, individual elements of the UWB antenna function as individual feeds for individual beams aimed in separate directions through the lens. In FIG. 10, the relationship between the adjacent feeds 30 and the adjacent beams 31 is shown. The Luneburg lens, including discretized Luneburg lens, are coupled to an anti-reflective layer 25 which is in turn is electrically coupled to a PUMA feed 26.

The lens and feed are designed in such a way that adjacent feeds will correspond to adjacent antenna beams. Assuming all elements are spaced correctly, the beams will overlap in such a way as to allow simultaneous illumination of an entire field of regard, in this case a field of roughly 60 degrees semi-hemispherical from boresite. By providing an RF matrix switch in the system that connects to all of the beam ports a number (n) of the ports can be illuminated simultaneously.

As an example, a 25-cm. (10-in.) antenna has a beamwidth on the order of 3 dB at 30 GHz. For the coverage of +/−45 degrees, a total of approximately 675 beams and feeds are required. This is a circular array of UWB antenna feeds approximately 30 elements across. If the feed surface also has a diameter of 25-cm., the feeds are spaced on the order of 1-cm apart.

The intersection of the adjacent scanned beams can be designed to be 1 dB to 3 dB below peak gain value.

The intersection of the adjacent scanned beams can be designed to allow for a sectored approach to the antenna, similar to a cellular network or a stationary radar aperture.

The anti-reflective layer may be homogeneous across the entire surface creating an equal match across the entire connection between the PUMA and Modified Luneburg Lens devices.

The anti-reflective layer may not be homogeneous across the entire surface in order to increase both the gain and directivity of the system.

The PUMA elements may be redesigned to be spaced differently in order to smooth the gain and directivity of the system across the entirety of coverage area.

The PUMA, the anti-reflective layer, and the Modified Luneburg Lens may be constructed using a single additive manufacturing process. In this embodiment, the entire structure would be printed in layers inside a single additive manufacturing machine, allowing for a low-cost approach to the production of the system.

The device may include a switching network in order to connect any single port of the PUMA array to a transmit/receive radio frequency chain up to and including the modulator/demodulator (MODEM).

The device may include one or a plurality of physical feed connections that are mechanically controlled to connect to each individual port of the PUMA array, allowing for the total device to connect any single port of the PUMA to a transmit/receive radio frequency chain up to and including the modulator/demodulator (MODEM). In this embodiment, the physical feed is mechanically guided by an X-Y plotter-style apparatus that can position the feed at any single PUMA port through mechanically changing the position in both the X and Y planes, similar to how an XY Plotter would work.

In an embodiment, an ultra-wideband array antenna such as the Planar Ultra-wideband modular antenna (PUMA) is connected to a Luneburg Lens, including a discretized Luneburg lens, that has been modified using Transformational Optics (TO) to flatten a portion of the lower hemisphere of the typically spherical lens. In an embodiment, the ultrawideband antenna (such as a PUMA) structure is used as a feed network for the described device.

In another embodiment, multiple ultra-wideband array such as the PUMA are connected to multiple flattened surfaces of the Luneburg lens. The PUMAs connected at several angles allow for full hemispherical coverage of the sky. FIGS. 12A and 12B illustrate the PUMAs connected to the Luneburg lens.

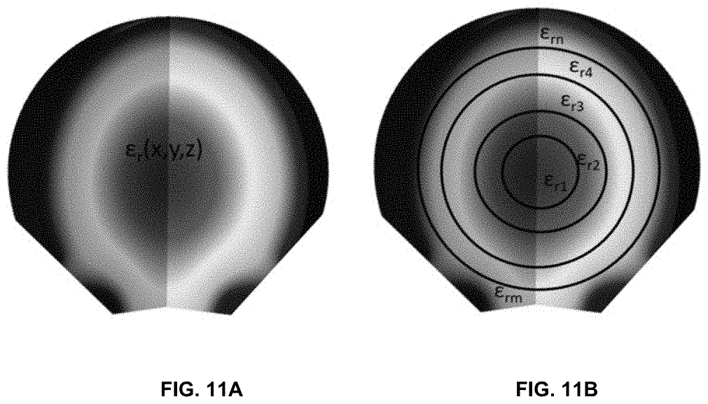

As depicted in FIG. 9, the modified Luneburg Lens can only cover approximately +/−50 degrees elevation angle. An anti-reflective layer 25 is coupled to the bottom of the modified Luneburg lens, including discrete Luneburg lens, which is, in turn, coupled to a PUMA feed 26. The anti-reflective layer may be a fixed dielectric anti-reflective layer.

Referenced to the ‘top’ of the antenna when it is oriented vertically. Said another way, when oriented vertically, the Modified Luneburg can only ‘see’ targets that are above 40 degrees in elevation. This limitation is similar to flat phased array antennas, which see a significant gain roll-off below about 45 degrees of elevation.

To solve this problem, instead of a single flat feed surface, multiple flat feed surfaces to illuminate different sectors of the lens is utilized. As depicted in FIG. 12A and FIG. 12B, the bottom feed is connected to a planar interface at the bottom and illuminates the top of the antenna. The feeds are connected to multiple geometrically designed interfaces at the side and illuminate the lower elevations. The antenna can have similar gains close to (or perhaps eventually even below) 0 degree elevation. Therefore, the antenna has a higher field of view and a full hemispherical coverage of the sky. Since each feed is independent and illuminates a different portion of the sky, with the right RF, switching, and modem structure, many beams and connections can be supported simultaneously. The following table provides an estimate for the gain and the number of feeds needed for different size lenses.

TABLE 1
Diameter, Gain, and Number of Feeds

| | | Ka (30 GHz) | |
|---|---|---|---|
| | Diameter | | # of |
| Diameter[m] | (inches) | G[dBi] | feeds |
| 0.15 | 5.85 | 30 | 600 |
| 0.25 | 9.75 | 35 | 2200 |
| 0.35 | 19.5 | 39 | 8800 |

This embodiment has the three following attributes: (1) Wideband—The lens is inherently wideband. Therefore, the bandwidth of the system is dictated by the RF and electronics used to drive the antenna; (2) Multi-beam. Since each beam/feed is independent of the rest, the number of beams supported is determined by the switching scheme and the number of modems employed. Nothing precludes the possibility of multiple connections within a single beam as long as the two connections are at different frequencies and (3) Wide area of coverage. With the enhanced Luneburg Approach, the limitation of +/−50 degrees of coverage is eliminated. The addition of multiple faces to illuminate different sectors of the lens leads to a lens that can provide full hemispherical coverage. This feature allows the antenna to be able to access low look angle satellites (close to the horizon), but it also allows the antenna to also be used for terrestrial (cell tower) communications. This means that this antenna is suitable to switch between satellite communications and tower-based (IE 5G) communications.

### Example 1

### Comparison of Additive Manufacturing Versus Discretized Approach

Additive manufacturing (also known as “3D printing”) is used to manufacture Luneburg lenses. On the computational side, the emergence of transformational optics (TO), coupled with high powered computers capable of solving massive computational problems, have opened up the possibility of designing much more complicated, non-uniform modified lens antennas. On the manufacturing side, 3D printing has become mature enough to allow the printing of RF structures. In one method, air and printing material are inter-mixed in different ratios in periodic structures to create a lens with constantly varying dielectric. The merging of TO with 3D printing has following problems prevent it from being viable for making production lenses.

However, the 3D Printing approach has limitations. For example, a $400,000 USD machine is required for each antenna in process. It requires 6 weeks of continuous machine time per antenna to achieve the required position for making a 10-inch antenna. Generally, there is an upper limit on the order of 16 inches on size for a lens using 3D printing. If there is a glitch during the manufacturing process, the whole antenna may need to be scrapped. These are severe problems from a commercialization standpoint.

In contrast, the inventors modified the transformational optics design process to work with a discretized structure, therefore enabling a modified Luneburg lens to be manufactured using the layered manufacturing process. In particular, this improved manufacturing processing allows a modified Luneburg lens to be commercialized. Using the discretized methods described herein, the only tooling required are molds for the layers. The manufacturing time is about 8 hours for 10 antennas using the manufacturing methods described herein. The upper limit on size exceeds 1 meter using the manufacturing methods described herein. There is a near term operational need for antennas approaching one meter in diameter, and even larger antennas could be sold if they could be produced. An antenna made using the method used herein is much more rugged than a 3D printed antenna. The realizable dielectric constant can be much higher (dielectric constant >15), enabling a wider range of designs and performance.

In summary, the discretized methods described herein are already viable for making rugged antennas in reasonable quantities at a reasonable price, and with time the price is likely to decrease.

### Example 2

### Simulated Radiation Patterns

A concern with the geometry of the Luneburg lens described herein possible signal interference/interruption between the two successive feeds placed along the edges of the two neighboring faces (both azimuth and elevation direction).

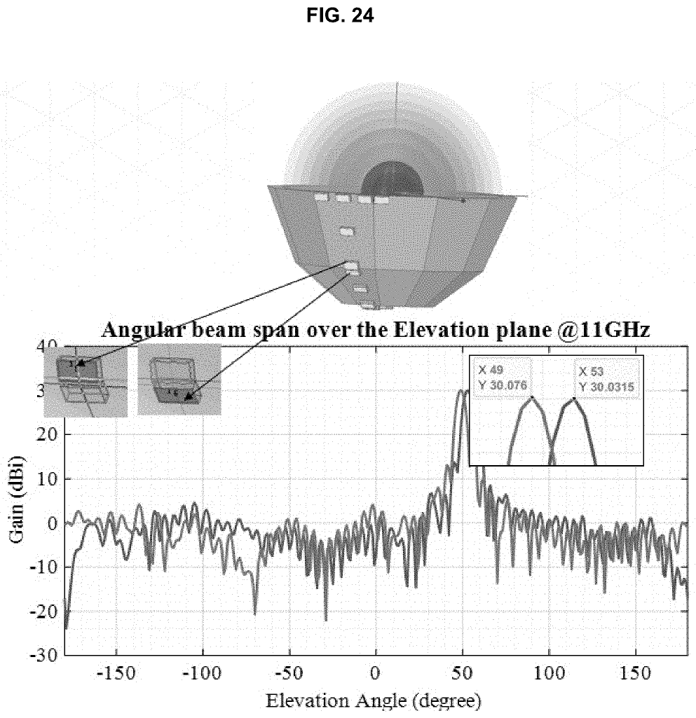

As shown in FIG. 24, the Luneburg lens described herein was excited using two waveguides placed along the edges of the two adjacent side and simulated the radiation patterns resulting from each of this waveguide source. From the simulation, it was observed that the geometry described herein (cupcake shape) of the lens's outer surface does not cause any problem or signal interruption. The two main beams resulting from the two-waveguide source has a 4° peak-to-peak beam span (49° and 53° in the corner of the figure) and the 3 dB crossover has 2° span from each of the main beam. Surprisingly, the inventors found that the Luneburg lens geometry described herein (cupcake shaped lens architecture) does not cause any signal interruption problem. The results were shown using a waveguide. However, any other feed source such as PUMA or other antenna could be used.

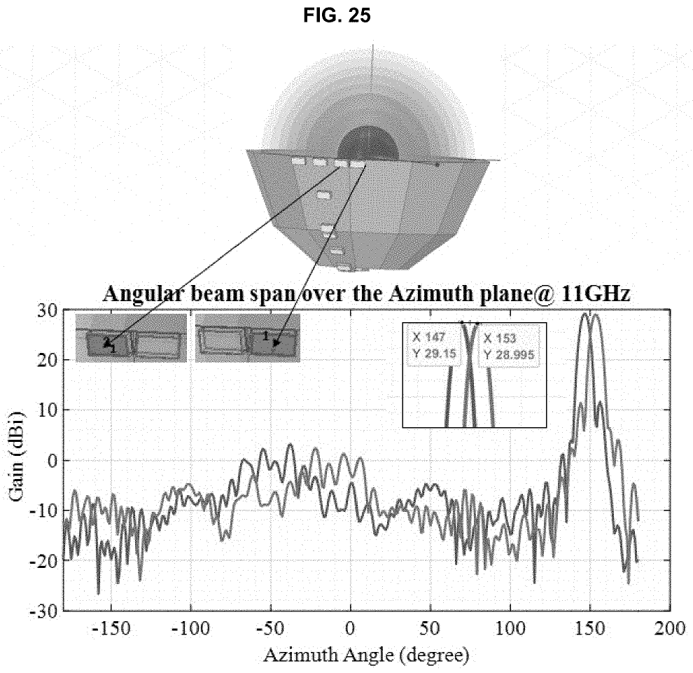

In FIG. 25, the same concern of possible interference was investigated. In this test, the azimuth planes instead of the elevation planes were tested. The transition region of the two adjacent trapezoidal faces may be a source of signal interruption, e.g., between the two successive feeds placed along the edges of the two neighboring trapezoidal faces (both azimuth and elevation direction). In FIG. 25, the lens' radiation patterns was tested by exciting the lens using two waveguides placed along the edges of the two neighboring trapezoidal faces. From the simulated results, the lens' architecture does not cause any signal transmit/receive problem or any other signal blockage problem. The two main beams resulting from each of the two-waveguide source placed along the edges of the two adjacent faces has a 6° peak-to-peak beam span (see, 147° and 153° in the corner of the figure) and the 3 dB crossover point lies in the middle of the two beams.

FIG. 25 depicts an exemplary Luneburg lens antenna described herein comprising two sets of trapezoidal shaped planar surfaces in the elevation direction and 10 trapezoidal planar surfaces in the azimuth direction. Several exemplary feed elements are shown attached to the trapezoidal planar surfaces. The antenna radiation patterns and the beam transition between the adjacent surfaces are shown. The successive beams resulting from the two feed elements located at the two adjacent sides (red shaded panels) creates a 3 dB beam overlapping. The two neighboring feed elements located at the two adjacent surfaces along the elevation plane has a 3 dB crossover point and the angular peak beam span is 4-degree.

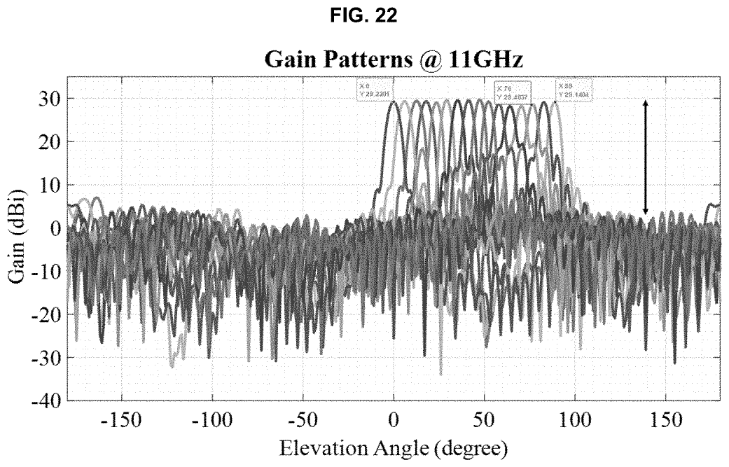

FIG. 22 shows an example simulated radiation patterns of this new lens antenna at 11 GHz as a function of the elevation angle. As seen from the figure, the lens antenna provides 0 to 90° (from the zenith of the sky to all the way down to horizon) beamscanning coverage. In this FIG. 33, the radiation patterns from 0 to 90° at 11 GHz frequency are show. The results are consistent for 0° to −90° elevation angle as well. Also, it is evident from the radiation patterns (FIG. 22) that the gain values are almost flat at all the elevation angle indicating that there is not any gain roll-off (e.g., signal degradation) as the antenna scans off-axis satellites.

This lens topology described herein will be able to achieve a wider beamscanning angle (from horizon to horizon) and this shows an improvement in tracking any satellites or objects from anywhere in the without having any signal interruption. Also, this lens antenna provides a very high gain value (which means the signal is be very strong and directive) and a high aperture efficiency (70% or more efficiency) which is critical for long distance communication.

While the present invention is described with respect to what is presently considered to be the preferred embodiments, it is understood that the invention is not limited to the disclosed embodiments. The present invention is intended to cover various modifications and equivalent arrangements included within the spirit and scope of the appended claims.

Furthermore, it is understood that this invention is not limited to the particular methodology, materials and modifications described and as such may, of course, vary. It is also understood that the terminology used herein is for the purpose of describing particular aspects only and is not intended to limit the scope of the present invention, which is limited only by the appended claims.

Although the invention has been described in some detail by way of illustration and example for purposes of clarity of understanding, it should be understood that certain changes and modifications may be practiced within the scope of the appended claims. Modifications of the above-described modes for carrying out the invention that would be understood in view of the foregoing disclosure or made apparent with routine practice or implementation of the invention to persons of skill in electrical engineering, telecommunications, computer science, and/or related fields are intended to be within the scope of the following claims.

All publications (e.g., Non-Patent Literature), patents, patent application publications, and patent applications mentioned in this specification are indicative of the level of skill of those skilled in the art to which this invention pertains. All such publications (e.g., Non-Patent Literature), patents, patent application publications, and patent applications are herein incorporated by reference to the same extent as if each individual publication, patent, patent application publication, or patent application was specifically and individually indicated to be incorporated by reference.

1-69. (canceled)

70. A Luneburg lens antenna comprising an upper hemisphere and a lower hemisphere,
wherein the upper hemisphere comprises a spherical Luneburg lens,
wherein the lower hemisphere comprises a plurality of geometrical interfaces arranged around the outer surface of the Luneburg lens in a southern hemisphere of the Luneburg lens,
and a substantially planar bottom.

71. The Luneburg lens antenna of claim 70, wherein the sets of pluralities of geometrical interfaces at a side of the Luneburg lens in a southern hemisphere of the Luneburg lens extending around of the Luneburg lens are arranged at an angle.

72. The Luneburg lens antenna of claim 70, wherein the pluralities of geometrical interfaces comprise about 10 geometrical interfaces in each set.

73. The Luneburg lens antenna of claim 70, wherein the substantially planar geometric interfaces are trapezoidal, rectangular, or square in shape, or a combination thereof.

74. The Luneburg lens antenna of claim 70, wherein there is a ledge at the mid-hemisphere conjunction of geometric interfaces comprising the lower hemisphere and the spherical Luneburg lens comprising the upper hemisphere.

75. The Luneburg lens antenna of claim 70, wherein the pluralities of geometrical interfaces comprise about 10 substantially planar surfaces in the azimuth direction.

76. The Luneburg lens antenna of claim 70, wherein the pluralities of geometrical interfaces have a near-air dielectric constant.

77. The Luneburg lens antenna of claim 76, wherein the dielectric constant is about 1.1.

78. The Luneburg lens antenna of claim 70, wherein the pluralities of geometrical interfaces are configured with a plurality of planar ultra-wideband modular antenna (PUMA) array elements.

79. The Luneburg lens antenna of claim 70, wherein the planar ultra-wideband modular antenna (PUMA) array elements comprise blocks of PUMA array elements, optionally an 4×4 array, 8×8 array, 16×16 array, 20×20 array, 50×50 array, 100×100 array, 250×250 array, or 300×300 array.

80. The Luneburg lens antenna of claim 70, wherein the feed sources are disposed on the geometrical interfaces, bottom, or both the geometrical interfaces and the bottom.

81. The Luneburg lens antenna of claim 70, wherein the feed sources located at the edges of the adjacent substantially planar surfaces are configured for 3 dB beam overlapping.

82. The Luneburg lens antenna of claim 70, wherein the Luneburg lens antenna and feed sources electronically coupled to back-end electronics to make the lens antenna electronically beam steering.

83. (canceled)

84. The Luneburg lens antenna of claim 70, wherein the Luneburg lens is coupled to feed arrays coupled to a beam switching network.

85. The Luneburg lens antenna of claim 70, wherein the feed element is coupled to a low noise amplifier (LNA), optionally an array of LNAs.

86. The Luneburg lens antenna of claim 70, wherein the lens comprises multiple concentric layers,
wherein each layer has a fixed dielectric constant, and
the lower hemisphere comprising a plurality of geometrical interfaces arranged around the outer surface of the Luneburg lens in a southern hemisphere of the Luneburg lens, and a substantially planar bottom layer have a fixed low dielectric constant.

87. The Luneburg lens antenna of claim 86, wherein the concentric layers have different dielectric constants.

88. The Luneburg lens antenna of claim 70, wherein at least one 2×2 Planar Ultrawideband and Modular Antenna (PUMA) array structure is operatively coupled to the planar interface, wherein the PUMA array structure is configured to function as a feed network to illuminate at least one or more beams of the Luneburg lens simultaneously; wherein the antenna is communicably coupled between multiple networks operating at different frequencies.

89. The Luneburg lens antenna of claim 70, wherein an illumination in a direction is at least increased or decreased via adjusting the focal point of the planar interface.

90. (canceled)

91. (canceled)

92. The Luneburg lens antenna of claim 70, wherein the antenna comprises a Luneburg Lens and a UWB Antenna coupled together by a substantially planar interface.

93. (canceled)

94. (canceled)

95. (canceled)

96. (canceled)

97. The Luneburg lens antenna of claim 70, wherein the Luneburg lens is made of a material selected from a cast resin or a machined material.

98. The Luneburg lens antenna of claim 97, wherein the cast resin is polyurethane or polystyrene.

99. The Luneburg lens antenna of claim 97, wherein the machined materials are Delrin® (Polyoxymethylene POM), Lexan® (polycarbonate resin thermoplastic), or a combination thereof.

100. A method for fabrication of the Luneburg lens antenna of claim 70 comprising casting in a mold, machining from a solid piece of material, made using an additive manufacturing process, or a combination thereof.

101. The method of claim 100, wherein the layers are cast individually, nested together, and assembled using an adhesive.
